(19) United States
(12) Patent Application Publication
(10) Pub. No.: US 2023/0085312 A1
(43) Pub. Date: Mar. 16, 2023

(54) SYSTEMS AND METHODS TO MEASURE OR CONTROL FUEL CELL STACK EXCESS HYDROGEN FLOW

(71) Applicants: CUMMINS INC., Columbus, IN (US); HYDROGENICS CORPORATION, Mississauga (CA)

(72) Inventors: Richard J. ANCIMER, Toronto (CA); Paolo FORTE, Maple (CA); Sumit TRIPATHI, Columbus, IN (US); Frank VAN DEN BOSCH, Toronto (CA); Eero TEENE, Hamilton (CA)

(21) Appl. No.: 17/898,188

(22) Filed: Aug. 29, 2022

Related U.S. Application Data
(60) Provisional application No. 63/242,931, filed on Sep. 10, 2021.

(51) Int. Cl. H01M 8/04746; H01M 8/0438; H01M 8/0432; H01M 8/247

(52) U.S. Cl. CPC H01M 8/04753; H01M 8/0438; H01M 8/0432; H01M 8/247; H01M 8/04776

(57) ABSTRACT

The present disclosure generally relates to systems and methods for determining, managing, and/or controlling excess hydrogen flow in a system comprising a fuel cell or fuel cell stack.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/242,931 filed on Sep. 10, 2021, the entire disclosure of which is hereby expressly incorporated herein by reference.

### TECHNICAL FIELD

The present disclosure relates to systems and methods for measuring, managing, and/or controlling excess hydrogen flow in a system comprising a fuel cell or a fuel cell stack.

### BACKGROUND

Vehicles and/or powertrains use fuel cells, fuel cell stacks, and/or fuel cell systems for their power needs. A minimum excess fuel target for a fuel cell system may be specified as a minimum level of an excess fuel target required by the fuel cell or fuel cell stack based on the operating conditions of the fuel cell, stack, or system. A fuel cell or fuel cell stack may have an excess fuel level higher than the minimum excess fuel target, but achieving that higher level may result in a high parasitic load on the fuel cell or fuel cell stack. For example, an excess fuel level higher than the minimum excess fuel target may be achieved by maintaining high fuel flow rates at the anode which may lead to a pressure loss in the fuel cell, stack, or system.

If the minimum level of excess fuel is not achieved, the performance or efficiency of the fuel cell or fuel cell stack may be reduced. Additionally, the rate of reversible and/or irreversible aging of the fuel cell membrane electrode assembly (MEA) may increase, leading to permanent reduction in efficiency or a shorter fuel cell life. This may require earlier replacement of the fuel cell or fuel cell stack at additional costs.

Currently, there are no methods or systems that enable a fuel management system to directly measure the excess fuel level in a system comprising a fuel cell or a fuel cell stack. The present disclosure relates to systems and methods for measuring, managing, and/or controlling excess hydrogen flow in a system comprising a fuel cell or a fuel cell stack.

### SUMMARY

Embodiments of the present invention are included to meet these and other needs.

In one aspect of the present disclosure, described herein, a fuel stack system or apparatus includes a first flow stream and a second flow stream mixing to form a third flow stream and a controller. The third flow stream flows through an anode inlet in a fuel cell stack in the fuel cell stack system. The controller compares an excess fuel ratio of the fuel cell stack system to a target excess fuel ratio of the fuel cell stack system.

In some embodiments, the fuel cell stack system may further include a blower, an ejector, or a by-pass valve. In some embodiments, the controller may determine when to operate the blower or may determine the blower speed depending on the excess fuel cell stack system. In some embodiments, the controller may determine operation of the by-pass valve depending on the excess fuel ratio of the fuel cell stack system. In some embodiments, the fuel cell stack system may include a first ejector and a second ejector. The controller may determine whether to operate the first ejector, the second ejector, or both the first and second ejectors depending on the excess fuel ratio of the fuel cell stack system.

In some embodiments, the fuel cell stack system may include at least one physical or virtual sensor. In some embodiments, the physical or virtual sensor may be a single point pressure sensor or a differential pressure sensor. In some embodiments, the physical or virtual sensor may measure pressure across the fuel cell stack, measure pressure across an ejector, or measure pressure across a blower in the fuel cell stack system. In some embodiments, the controller may further measure mass flow rate in the first flow stream or the mass flow rate in the second flow stream. The controller may determine an entrainment ratio of the fuel cell stack system based on the measured pressure across the fuel cell stack or the measured pressure across the ejector, and based on the measured mass flow rate in the first flow stream or the measured mass flow rate in the second flow stream.

In some embodiments, if the entrainment ratio of the system is different than a target entrainment ratio, the controller may operate the blower, alter the speed of the blower, operate one or more ejectors, or the by-pass valve. If the one or more ejectors includes a first ejector and a second ejector, the controller may determine the operation of the first ejector and the second ejector. In some embodiments, the entrainment ratio may have an uncertainty of less than 12%.

In some embodiments, the physical or virtual sensor may include a temperature sensor. In some embodiments, the temperature sensor may measure a temperature difference across a mixing point in the fuel cell stack system. In some embodiments, the controller may determine an entrainment ratio of the fuel cell stack system based on the temperature difference across the mixing point by using energy balance in the fuel cell stack system. In some embodiments, the temperature difference across the mixing point may be maximized

In some embodiments, if the entrainment ratio of the fuel cell stack system is different than a target entrainment ratio, the controller may operate a blower, alter the speed of the blower, operate one or more ejectors, or operate a by-pass valve. If the one or more ejectors includes a first ejector and a second ejector, the controller may determine the operation of the first ejector and the second ejector.

In some embodiments, the controller may use a model to determine an entrainment ratio of the fuel cell stack system based on operating conditions of the fuel cell stack system.

In some embodiments, a model may be used to determine the entrainment ratio of the fuel cell stack system based on operating conditions of the fuel cell stack system. The model may be a correlational model or a component based model. In some embodiments, the fuel cell stack system may include a first ejector and a second ejector. The controller may further determine whether to operate the first ejector, the second ejector, or both the first ejector and the second ejector depending on the excess fuel ratio of the fuel cell stack system.

In a second aspect of the present disclosure, a method of determining an excess fuel ratio of a fuel cell stack system or apparatus includes the steps of mixing a first flow stream and a second flow stream to form a third flow stream, flowing the third flow stream through an anode inlet in a fuel cell stack, using a controller to compare an excess fuel ratio of the fuel cell stack system to a target excess fuel ratio of the fuel cell stack system, and measuring pressure across the fuel cell stack or measuring pressure across an ejector, or measuring pressure across a blower by using a physical or virtual sensor.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is an illustration of a fuel cell system including one or more fuel cell stacks connected to a balance of plant.

FIG. 1B is an illustration of a fuel cell system having fuel cell modules, each fuel cell module having fuel cell stacks and/or fuel cells.

FIG. 1C is an illustration of components of a fuel cell in the fuel cell stack.

FIG. 2 is a graph showing the operating curves of a system comprising a fuel cell or fuel cell stack.

FIG. 3 is a schematic showing an embodiment of a venturi or ejector in a fuel cell stack system.

FIG. 4 is a schematic showing a flow restriction used along with a venturi or ejector in a fuel cell stack system.

FIG. 5 is a schematic of an embodiment of a venturi or ejector in a fuel cell stack system comprising two locations for performing energy balance.

FIG. 6 is a schematic showing a flow restriction used along with a venturi or ejector in a fuel cell stack system comprising two locations for performing energy balance.

### DETAILED DESCRIPTION

The present disclosure relates to systems and methods for determining, managing, and/or excess hydrogen flow in a system comprising a fuel cell 20 or fuel cell stack 12. More specifically, the present disclosure relates to using pressure and/or temperature measurements for determining, managing, and/or excess hydrogen flow in a system comprising a fuel cell 20 or fuel cell stack 12. The present disclosure also relates to using computational models for determining, and/or managing excess hydrogen flow in a system comprising a fuel cell 20 or fuel cell stack 12. This disclosure relates to overcoming challenges in a fuel management system for directly measuring the excess fuel flow.

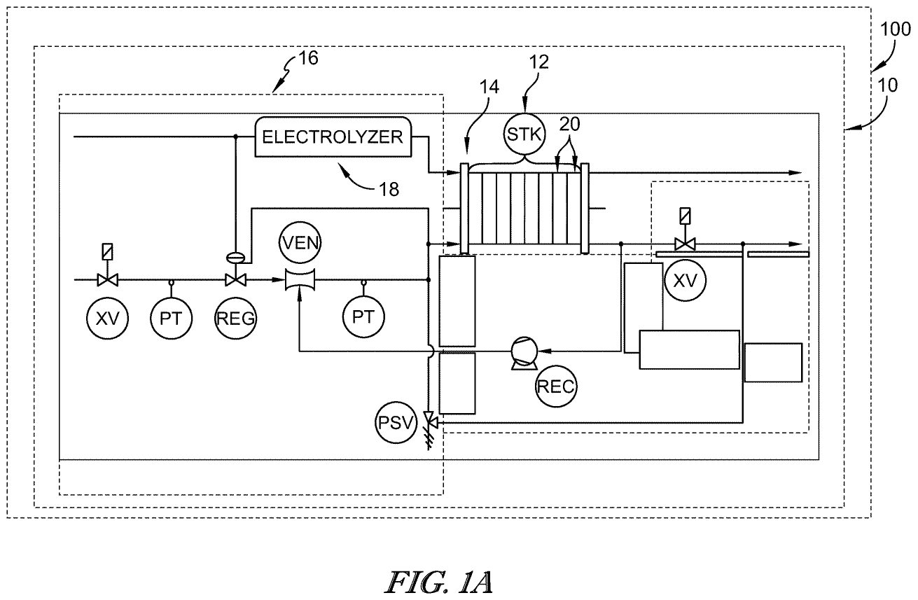

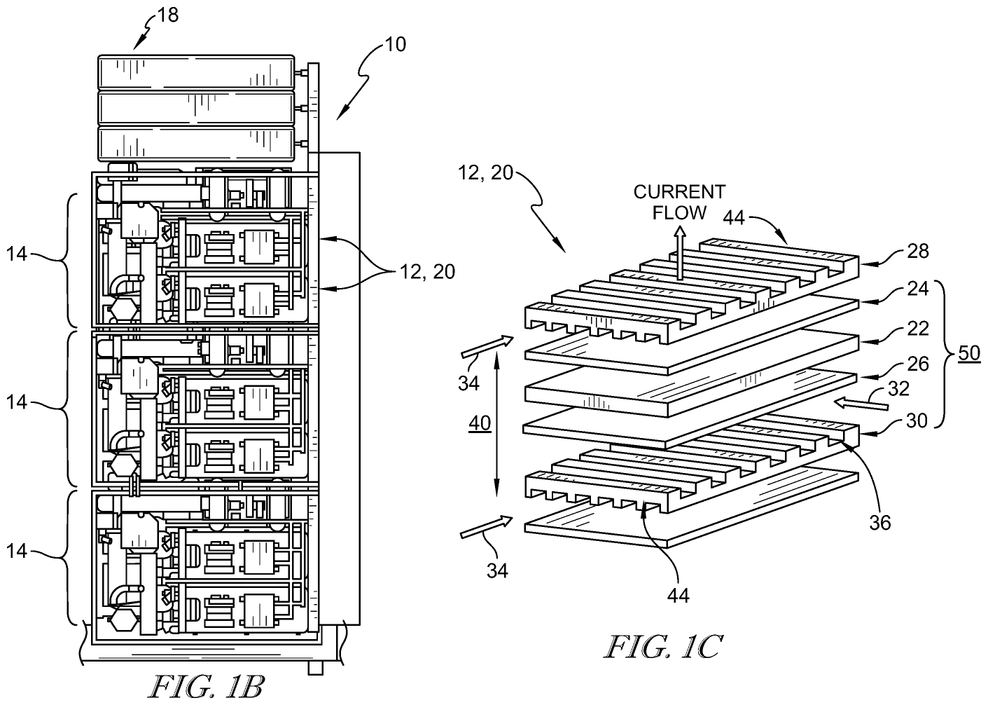

As shown in FIG. 1A, fuel cell systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B. Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16 (see FIG. 1A). In another embodiment, the fuel cell system 10 is not connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

A fuel cell 20 or fuel cell stack 12 power module may comprise a fuel management system that controls, manages, implements, or determines the flow of the primary fuel 32 (e.g., hydrogen) as a fuel stream to the anode. The fuel flow control may occur through an anode inlet 212 at a rate that matches, exceeds, or is less than the fuel consumption rate of the fuel cell 20 or fuel cell stack 12. The fuel flow control may depend on the recirculation rate of the fuel stream exhaust from the fuel cell or fuel cell stack outlet 214 back to the anode inlet 212. The fuel flow control may depend on the operation of the fuel cell 20 or fuel cell stack 12 at a target pressure. The fuel flow control may depend on the maintenance of a pressure differential between the anode and cathode streams within a specified target range.

A blower and/or a pump 220 (e.g., a recirculation pump) may function at a capacity proportional to the pressure loss in the fuel cell 20 or fuel cell stack 12. The blower and/or the pump 220 may also function at a capacity proportional to the volumetric flow rate through the blower and/or the pump 220. The blower and/or a pump 220 may use additional power to compensate for the pressure loss. Use of additional power by the blower and/or the pump 220 may result in a high parasitic load on the fuel cell 20 or fuel cell stack 12.

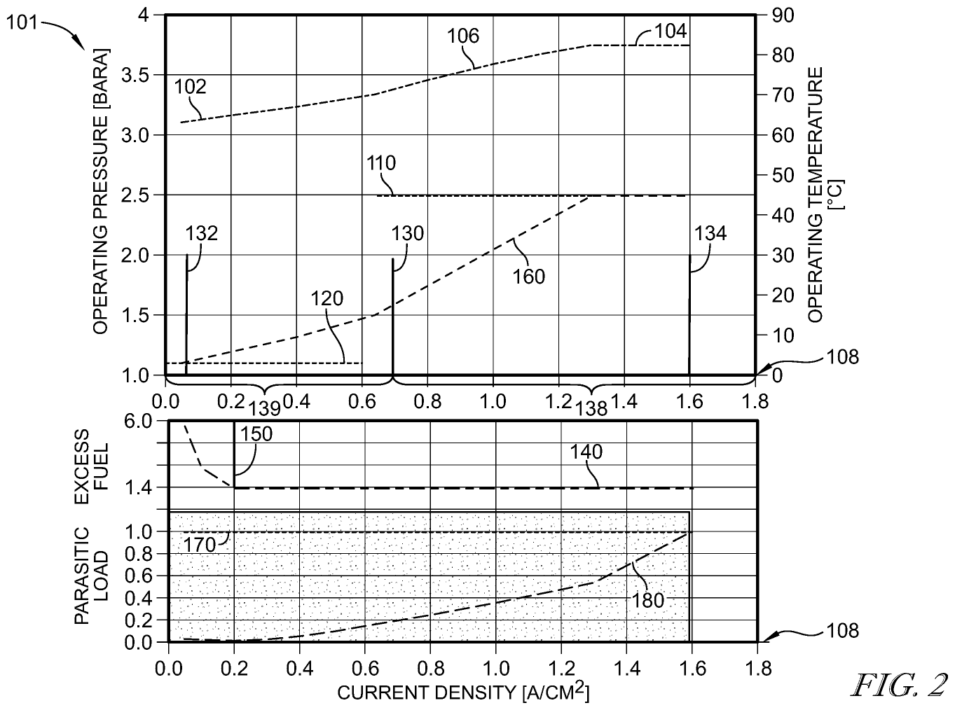

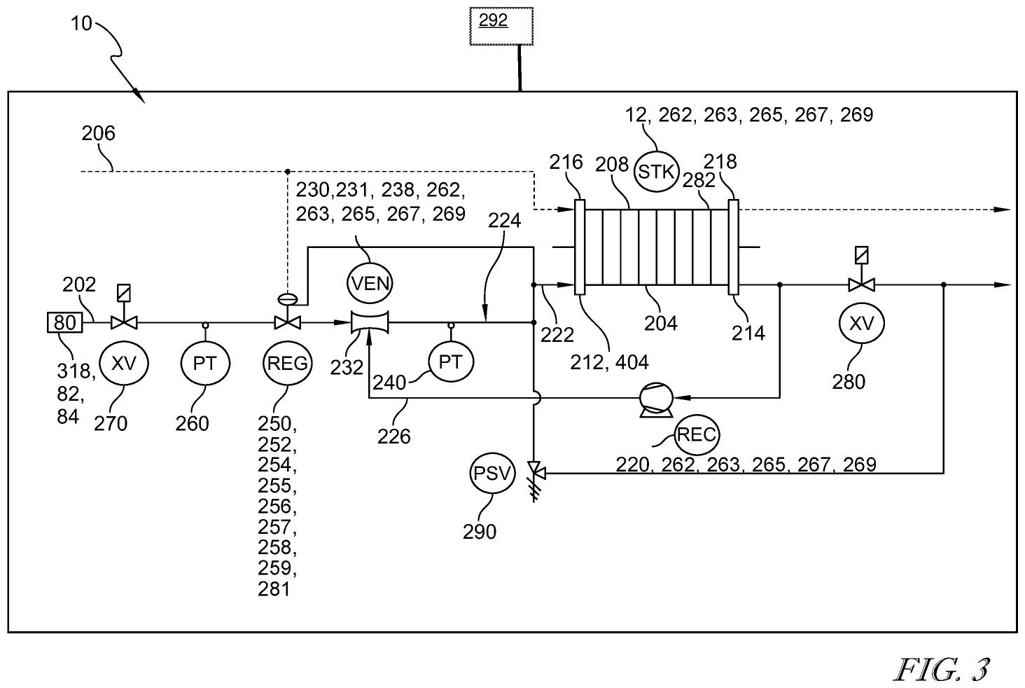

One embodiment of the operating characteristics of fuel cell system 10 comprising a fuel cell system 10 comprising a fuel cell 20 or fuel cell stack 12 is illustrated in graph 101 in FIG. 2. Operating pressures and the associated operating temperatures are shown as a function of current density 108. The fuel cell 20 or fuel cell stack 12 may be required to operate within a pressure range known as anode inlet manifold pressure (P_{AIM}) measured at the anode inlet manifold 404 shown in FIG. 3.

A highest anode inlet manifold pressure (P_{AIM_HI}) of a fuel cell 20 or fuel cell stack 12 is denoted by 110. A lowest anode inlet manifold pressure (P_{AIM_HI}) of a fuel cell 20 or fuel cell stack 12 is denoted by 120. The range 160 between the highest anode inlet manifold pressure (P_{AIM_HI}) 110 and the lowest anode inlet manifold pressure (P_{AIM_LO}) 120 indicates a target anode inlet manifold pressure range or operating pressure. A target temperature of the fuel cell system 10 may range from a low fuel supply operating temperature (T_{CV_LO}) 102 to a high fuel supply operating temperature (T_{CV_HI}) 104.

It is critical to operate the fuel cell 20 or fuel cell stack 12 at a pressure that ranges from about or approximately the highest anode inlet manifold pressure (P_{AIM_HI}) 110 to about or approximately the lowest anode inlet manifold pressure (P_{AIM_LO}) 120 when the fuel cell 20 or fuel cell stack 12 is operating above a critical current density (i_{_LO_CR}) 130. In some embodiments, the critical current density (i_{_LO_CR}) 130 may be at about 0.7 A/cm². In other embodiments, the critical current density (i_{_LO_CR}) 130 may be at about 0.6 A/cm². In some further embodiments, the critical current density (i_{_LO_CR}) 130 may be higher or lower than 0.7 A/cm², such as ranging from about 0.5 A/cm² to about 0.9 A/cm², including every current density 108 or range of current density 108 comprised therein.

The fuel cell 20 or fuel cell stack 12 may operate at a high current density 138, which may be higher than the critical current density (i_{_LO_CR}) 130. The high current density 138 may range from about 1.3 A/cm² to about 2.0 A/cm², or about 1.3 A/cm² to about 1.6 A/cm², or about 1.0 A/cm² to about 1.6 A/cm², including every current density 108 or range of current density 108 comprised therein.

In some embodiments, operating the fuel cell 20 or fuel cell stack 12 at such high current density 138 (e.g., at about 1.6 A/cm²) will result in operating the fuel cell 20 or fuel cell stack 12 at pressures and temperatures different from optimal target operating pressures and operating temperatures. Operating the fuel cell 20 or fuel cell stack 12 at pressures and temperatures different from the optimal target operating pressures and operating temperatures may lower the efficiency of the fuel cell 20 or fuel cell stack 12. Such operation may also result in damage to the fuel cell 20 or fuel cell stack 12 because of MEA 22 degradation (e.g., due to starvation, flooding and/or relative humidity effects). In some embodiments, there may be more flexibility in the fuel cell 20 or fuel cell stack 12 operating pressure and operating temperature when the fuel cell 20 or fuel cell stack 12 is operating below the critical current density (i_{_LO_CR}) 130. The present operating system comprising the fuel cell 20 or fuel cell stack 12 can operate at a minimum current density (i_{MIN}) 132 and/or a maximum current density (i_{MAX}) 134.

In one embodiment, the fuel cell system 10 comprising the fuel cell 20 or fuel cell stack 12 may operate in a functional range that may be different than that indicated by the curve 160 in FIG. 2. The fuel cell system 10 may operate at higher pressures (e.g., the highest anode inlet manifold pressure (P_{AIM_HI}) 110) or at a current density 108 as low as the critical current density (i_{_LO_CR})130. For example, the fuel cell system 10 may extend steady state operation at about 2.5 bara down to about the critical current density (i_{_LO_CR}) 130. Pressure measurements in bara refer to the absolute pressure in bar.

FIG. 3 illustrates one embodiment of a fuel cell system 10 comprising a fuel cell stack 12, a mechanical regulator 250, a recirculation pump or blower 220 in series or in parallel to the fuel cell stack 12, an exhaust valve 280, a purge valve 284, a shut off valve 270, a pressure transfer valve 290, one or more pressure transducers 240/260, and a venturi or an ejector 230. In some embodiments, the fuel cell system 10 may comprise one or more fuel cell stacks 12 and/or one or more fuel cells 20. In other embodiments, there may also be one or multiple valves, sensors, compressors, regulators, blowers, injectors, ejectors, and/or other devices in series or in parallel with the fuel cell stack 12.

In one embodiment of the fuel cell system 10, an anode inlet stream 222, flows through an anode 204 end of the fuel cell stack 12. Typically, the anode inlet stream 222 may be a mixture of fresh fuel (e.g., H₂) and anode exhaust (e.g., H₂ fuel and/or water). Conversely, oxidant 206 (e.g., air, oxygen, or humidified air) may flow through the cathode 208 end of the fuel cell stack 12.

Excess fuel may be provided at the anode inlet 212 to avoid fuel starvation towards the anode outlet 214. In some embodiments, the excess fuel ratio (λ_{H2}) may be greater than or equal to about 1.3 to avoid fuel starvation. Recirculated flow may be provided at the anode inlet 212 to support humidification of the membrane electrode assembly (MEA) 22. Water content of the anode inlet stream 222 or the relative humidity of the anode inlet stream 222 may impact the performance and health of the fuel cell stack 12. For example, low inlet humidity may lead to a drier MEA 22 resulting in reduced performance Low inlet humidity may also induce stresses that can lead to permanent damage to the MEA 22 . . . .

High anode gas inlet relative humidity levels may lead to flooding within the fuel cell 20 or fuel cell stack 12, which can induce local starvation and/or other effects that may reduce fuel cell performance and/or damage the membrane electrode assembly (MEA) 22. In some embodiments, there may be an optimal inlet relative humidity range in which fuel cell performance is improved and membrane electrode assembly (MEA) 22 degradation rate is minimized. For example, the fuel cell 20 or fuel cell stack 12 may achieve optimal performance when the relative humidity level of the anode inlet stream 222 is in the range of about 30% to about 35%, including any percentage or range comprised therein.

Referring to FIG. 3, if the anode stream at the anode outlet 214 is saturated at the fuel cell operating temperature, and if the anode inlet stream relative humidity level is about 30%, a minimum excess fuel ratio (λ_{H2}) of about 1.37 to about 1.4 may be needed to maintain fuel cell performance and/or avoid damage to the membrane electrode assembly (MEA) 22. In other embodiments, if the anode stream at the anode outlet 214 is saturated at the fuel cell operating temperature, and if the relative humidity level is about 35%, a minimum excess fuel ratio (λ_{H2}) of about 1.45 to about 1.51 may be needed to maintain fuel cell performance and/or avoid damage to the membrane electrode assembly (MEA) 22.

Referring to FIG. 1C, coolant 36 flow in a fuel cell 20 or fuel cell stack 12 is provided to manage the heat generated within the fuel cell 20 or fuel cell stack 12 that may arise due to inefficiencies. Coolant 36 flow passages may be designed to enable effective heat transfer to remove any waste heat. A finite coolant heat capacity based on the coolant flow rate and coolant specific heat capacity may result in temperature variations across the fuel cell 20 or fuel cell stack 12. In some embodiments, design specifications may limit the allowable temperature rise across the fuel cell 20 or fuel cell stack 12. For example, at the beginning of life (BoL), a sufficiently high coolant flow rate may be required to limit the temperature rise to be about 5° C. to about 7° C. The inlet coolant temperature may be managed separately to meet an inlet temperature target.

As the fuel cell 20 or fuel cell stack 12 ages, the amount of heat generated within the fuel cell 20 or fuel cell stack 12 may increase. If the coolant 36 flow is maintained at the levels that meet the design specifications of the beginning of life (BoL) temperature rise, the temperature rise after aging may be more than about 5° C. to about 7° C.

As the fuel cells 20 or fuel cell 12 stacks are designed with effective heat transfer, the local anode and cathode stream temperatures may be similar to the local coolant temperature. The anode outlet stream temperature may also affect the excess fuel ratio (λ_{H2}). The anode outlet stream temperature may be closer to the coolant inlet temperature, which may be different than the fuel cell operating temperature. Thus, the anode outlet stream temperature may be up to about 7° C. lower at the beginning of life (BoL) and may be about 10° C. lower at end of life (EoL).

The coolant 36 temperature variations across the fuel cell 20 or fuel cell stack 12 may influence the cathode and anode inlet and/or outlet stream temperatures depending on the fuel cell 20 or fuel cell stack 12 design. The fuel cell 20 or fuel cell stack 12 may be designed in many configurations with three flow streams-anode stream, cathode stream, coolant stream. For example, each of the flow streams through the fuel cell 20 or fuel cell stack 12 may have a single inlet and outlet. The flow streams may be oriented to co-flow, counter-flow, or cross-flow.

Geometric (space) constraints may preclude cross-flow, and require that two of the three streams be co-flow with the third being counter-flow. If the fuel cell 20 or fuel cell stack 12 is designed with the anode stream as counter-flow, then the cathode stream and coolant stream are co-flow. In this configuration, the anode stream outlet temperature may be close to the inlet coolant temperature, whereas the cathode inlet/outlet stream temperature may be close to the inlet/outlet coolant temperature.

Since the fuel cell 20 or fuel cell stack 12 temperature may be controlled to a target cathode outlet temperature by controlling the coolant inlet temperature, in the embodiment described above, the cathode outlet temperature may be near the coolant outlet temperature. The cathode inlet temperature may be lower than the outlet temperature by about 5° C. to about 7° C. at BoL, and by about 10° C. lower at EoL. In this same configuration, the temperature of the anode outlet stream may be near the cathode inlet temperature and may be lower than the target fuel cell temperature target by about 5° C. to about 7° C. at BoL, and by about 10° C. lower at EoL. In some embodiments, the temperature difference in any configuration during BoL may range from about 1° C. to about 3° C., 3° C. to about 5° C., 5° C. to about 7° C., 7° C. to about 10° C., 10° C. to about 12° C., or any specific temperature or range comprised therein. In other embodiments, the temperature difference in any configuration during EoL may range from about 5° C. to about 7° C., 7° C. to about 10° C., 10° C. to about 12° C., 12° C. to about 15° C., or any specific temperature or range comprised therein.

The fuel cell 20 or fuel cell stack 22 may be designed such that the anode stream co-flows with the coolant 36, and the anode outlet stream temperature may be higher than the anode gas inlet temperature.

If the anode outlet stream temperature is about 10° C. lower than the target temperature, and if the relative humidity level is about 30%, a minimum excess fuel ratio (λ_{H2}) of about 1.40 to about 1.49 may be needed to maintain fuel cell performance and/or avoid damage to the membrane electrode assembly (MEA) 22. If the anode outlet stream temperature is about 10° C. lower than the target temperature, and if the relative humidity level is about 35%, a minimum excess fuel ratio (λ_{H2}) of about 1.50 to about 1.8 may be needed to maintain fuel cell performance and/or avoid damage to the membrane electrode assembly (MEA) 22. The increase in the needed excess fuel ratio (λ_{H2}) may be more noticeable at high current densities where the change in temperature is larger.

The source of the excess fuel and water content in a fuel cell 20 may be from a secondary or recirculated flow 226. Composition of the secondary flow 226 in the fuel cell system 10 is dependent on its composition of anode outlet stream 225. In some embodiments, the anode outlet stream 225 may be saturated with water at a given anode outlet stream temperature and pressure. Thus, the variation in the composition of the secondary flow 226 may be taken into account when determining a required secondary flow 226 to meet the excess fuel or relative humidity targets of the anode inlet stream 222.

The required flow rate of the secondary flow 226 can be determined by either the need for excess fuel, or by the need for increased water content, whichever calls for a higher flow of the secondary flow 226. The required flow of the secondary flow 226 can be expressed as the target entrainment ratio (ER). The entrainment ratio (ER) is defined as the ratio of mass flow rate of the low pressure stream (e.g., the secondary mass flow rate) to the mass flow rate of the high pressure stream (e.g., the primary mass flow rate). Alternatively, a target effective excess fuel ratio or a minimum required fuel ratio may account for either the need for excess fuel, or for the increased water content of the anode inlet stream 222.

Excess fuel ratio (λ_{H2}) or the anode stoichiometry ratio is defined as the ratio of anode inlet stream 222 flow rate to the fuel consumed in the fuel cell 20 or fuel cell stack 12. Excess fuel ratio (λ_{H2}) may be used to represent the required composition of the secondary flow 226 to meet the required anode inlet stream 222 characteristics. The required anode inlet stream 222 characteristics may be the more stringent of excess fuel ratio or relative humidity requirements of the fuel cell system 10. Minimum required excess fuel ratio (λ_{H2}) 140 as a function of current density 108 is shown in FIG. 2. In some embodiments, the fuel cell system 10 requires a fuel amount at or above the minimum required excess fuel ratio (λ_{H2}) 140.

In other embodiments, the fuel cell system 10 may require a target water or humidity level, which may affect the excess fuel ratio (λ_{H2}) 140. The excess fuel ratio (λ) 140 may be flat across the fuel cell system 10 operating range except at low current densities 108, such as at a current density 108 at or below an excess fuel ratio current density threshold (i_{_λ_THV}) 150. Alternatively, or additionally, the excess fuel ratio (λ) 140 may change with a change in current density 108.

In some embodiments, the excess fuel ratio (λ_{H2}) 140 above the excess fuel ratio current density threshold (i_{_λ_THV}) 150 may be in the range from about 1.3 to about 1.9, including any ratio comprised therein. In one preferable embodiment, the excess fuel ratio (λ_{H2}) 140 above the excess fuel ratio current density threshold (i_{_λ_THV}) 150 may be in the range of about 1.4 to about 1.6, including any ratio or range of ratio comprised therein.

In some embodiments, the excess fuel ratio current density threshold (i_{_λ_THV}) 150 of the fuel cell system 10 may be at or about 0.2 A/cm². In other embodiments, the excess fuel ratio current density threshold (i_{_λ_THV}) 150 may be at a different current density 108. For example, the excess fuel ratio current density threshold (i_{_λ_THV}) 150 may be at a current density 108 in the range of about 0.05 A/cm² to about 0.4 A/cm², including any current density 108 or range of current density 108 comprised therein. In one preferable embodiment, the excess fuel ratio current density threshold (i_{_λ_THV}) 150 may be about 0.1 A/cm² or about 0.2 A/cm². The excess fuel ratio current density threshold (i_{_λ_THV}) 150 may depend on the operating conditions of the fuel cell 20 or fuel cell stack 12.

In one embodiment, if the fuel cell 20 or fuel cell stack 12 is operating below the excess fuel ratio current density threshold (i_{_λ_THV}) 150, a minimum volumetric flow rate may be maintained through the anode 204 to flush out any liquid water that might form in the fuel cell 20 or fuel cell stack 12. At low flow rates (e.g., below about 0.2 A/cm² or below about 0.1 A/cm²), there may be flooding in the fuel cell 20 or fuel cell stack 12. If the minimum volumetric flow rate is below the excess fuel ratio current density threshold (i_{_λ_THV}) 150, the rate of fuel cell 20 or fuel cell stack 12 degradation may increase and the performance of the fuel cell or fuel cell stack may be adversely affected.

The venturi or an ejector 230 may be used in the fuel cell system 10. The venturi or ejector 230 may be sized, such that the fuel cell system 10 may not require the assistance of a recirculation pump 220, such as a blower, at certain current densities 108. Absence of usage of the recirculation pump or blower 220 may result in a decrease in parasitic load, as shown by the curves 170 and 180 of FIG. 2. The curve 170 shows a fraction of flow that is delivered by the recirculation pump or blower 220 in the absence of a venturi or ejector 230. The curve 180 shows the corresponding parasitic load.

The parasitic load may increase with an increase in current density, as shown by the curve 180. This recirculation pump or blower 220 may function at a capacity proportional to pressure loss in the fuel cell 20 or fuel cell stack 12 and/or proportional to the required flow rate of the secondary flow 226 in the fuel cell 20 or fuel cell stack 12. The fuel cell 20 or fuel cell stack 12 may be initially operating at high current density 138 and/or at high operating temperatures and pressures, such that the fuel cell load under this initial operating condition is high. The fuel cell load is defined as: Load=stack power=current x fuel cell or fuel cell stack voltage =current density x fuel cell area x fuel cell or fuel cell stack voltage. The fuel cell 20 or fuel cell stack 12 may be in a load shedding state when the load demand for power is rapidly reduced or shed requiring the fuel cell 20 or fuel cell stack 12 to reduce the current delivered

During transient operations in the fuel cell 20 or fuel cell stack 12, the operating pressure in the fuel cell 20 or fuel cell stack 12 may change based on the changes in the fuel cell 20 or fuel cell stack 12 operating temperature. For example, during load shedding, the fuel cell system 10 may have an operating pressure that corresponds to a transient operating pressure (P_{_AIM_TRS}) that may be greater than its steady state operating pressure (P_{AIM_SS}). In some embodiments, the transient operating pressure (P_{_AIM_TRS}) may equal the highest anode inlet manifold pressure (P_{AINM_HI}) 110 even at low current densities 108. During load acceptance, the rate of increase in current density 108 is limited, and the steady state operating pressure (P_{AIM_SS}) may equal the anode inlet manifold pressure (P_{AIM}).

During load acceptance, the fuel cell 20 or fuel cell stack 12 operating temperature may overshoot the target operating temperature due to imperfect temperature control via coolant thermostatic controls. The operating pressure under such conditions is higher than the operating pressure under nominal (steady state) operation. This situation is similar to that which occurs during rapid load shedding.

In one embodiment, the operating pressure of the fuel cell 20 or fuel cell stack 12 may optimize the balance between enabling efficient fuel cell 20 or fuel cell stack 12 operation and the parasitic load required to operate at the chosen operating pressure (e.g., the parasitic load of an air compressor, a blower, and/or a pump). In some embodiments, the operating temperature, operating pressure, and/or excess air ratio may maintain a target relative humidity (RH) for the fuel cell 20 or fuel cell stack 12 operation. The operating temperature, operating pressure, and/or excess air ratio may be determined by targeting a specific value for the relative humidity (RH) at the cathode 208.

The excess air ratio is defined similarly to excess fuel ratio (λ_{H2}) 140, but refers to the cathode 208 side flow (i.e., excess O₂ in the air). The combination of excess air ratio, pressure and temperature are used together to control humidity on the cathode 208 side, which in turn impacts water content on the anode 204 (H₂) side. In one embodiment, temperature, pressure, and excess air ratio that vary with current density may be used to control humidity on the cathode 208 side. In some embodiments, excess air ratio may be about 2.0.

In other embodiments, excess air ratio may be in the range of about 1.7 to about 2.1, including any ratio or range of ratio comprised therein. In some other embodiments, excess air ratio may be in the range of about 1.8 to about 1.9, including any ratio or range of ratio comprised therein, under pressurized operation. Excess air ratio may increase to below an air threshold current to keep volumetric flow rate high enough to prevent flooding in the fuel cell 20 or fuel cell stack 12 on the cathode 208 side.

The target relative humidity (RH) may be maintained by using a humidification device in combination with the operating pressure and operating temperature. For example, a humidification device may be used on the cathode 208 side of the fuel cell 20 or fuel cell stack 12. If the target relative humidity (RH) and the target operating pressure of the fuel cell 20 or fuel cell stack 12 are specified, the target temperature for the fuel cell 20 or fuel cell stack 12 operation may be determined.

The mechanical regulator 250 is a control valve 256 that may be used to control the flow of fresh fuel 202 also referred to as primary flow, primary mass flow, primary fuel, or motive flow to the anode 204. . The control valve 256 may be a proportional control valve, or an injector instead of the mechanical regulator 250 (e.g., a dome regulated mechanical regulator). The control valve 256 may comprise an inner valve 258, coil 255, or solenoid 257 that controls the opening or closing of the control valve 256.

Pressure differential between the gas streams (e.g. anode inlet stream 222 and air 206) at the anode 204 and the cathode 208 may provide an input signal 254 to a controller 252 in the mechanical regulator 250. The controller 252 of the mechanical regulator 250 may determine the flow of the anode inlet stream 222 through an anode inlet 212 at the anode 204. The control valve 256 may be a proportional control valve, or an injector. In other embodiments, the control valve 256 may comprise an inner valve 258, coil 255, or solenoid 257 that controls the opening or closing of the control valve 256. The input signal 254 from the anode 204 and/or cathode 208 of the fuel cell 20 or fuel cell stack 12 may be a physical signal or a virtual (e.g., an electronic) signal. The input signal 254 may be any type of communicative or computer signal known in the art.

Flow rate of the primary flow 202, or a primary flow rate, may be controlled to match the fuel consumption in the fuel cell stack 12 based on the operating pressure (e.g., anode pressure). In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using the mechanical regulator 250. In some embodiments, pressure at the cathode 208 is controlled and/or maintained at a target level via cathode side controls 282.

A mechanically regulated approach, such as by employing actuators 282, may use pressure signals 281 from a cathode/air inlet 216 to control mass flow and maintain an appropriate pressure on the cathode 208 side of the fuel cell stack 12. In some embodiments, pressure signals 218 from cathode 208 side are inputs to the mechanical regulator 250. In some embodiments, the anode 204 side mass flow and anode 204 side pressure may be controlled by using the pressure signals 281 from cathode 208 side and measuring one or more anode 204 side conditions.

The pressure signals 281 from cathode 208 side may change the position of an inner valve 258 in the mechanical regulator 250 to control mass flow through the mechanical regulator 250 and maintain the target pressure differential between the anode 204 and the cathode 208. The input signal 254 that acts on the mechanical regulator 250 is effectively a pressure differential that acts on a diaphragm 257 or other parts of the mechanical regulator 250. No other direct measurement of the pressure differential may be undertaken.

A single point pressure at the anode 204 may be calculated to be the cathode 208 side pressure plus the pressure differential between the gas streams (e.g., 222) at the anode 204 and the gas streams (e.g., 206) at the cathode 208. Single point pressure may be absolute pressure or gauge pressure.

The venturi or ejector 230 may draw the secondary flow 226, also referred to as secondary mass flow, entrainment flow, or recirculation flow, using a flow pressure across an anode gas recirculation (AGR) loop 224. As discussed later, the venturi or ejector 230 may take advantage of the available excess enthalpy from the higher pressure primary flow to draw in the secondary flow 226, working against the pressure losses through the AGR loop 224. The anode gas recirculation loop 224 may include the venturi or ejector 230, the fuel cell stack 12, and a secondary inlet 232, such as one comprised in a suction chamber 620 in the venturi or ejector 230, and/or other piping, valves, channels, manifolds associated with the venturi or ejector 230 and/or fuel cell stack 12. The recirculation pump or blower 220 may increase or decrease the differential pressure across the AGR loop 224.

The fuel cell system 10 may require a target water or humidity level, which may drive the flow of saturated secondary flow 226. The saturated secondary flow 226 may then drive the primary flow 202, such that the target excess fuel ratio (λ_{H2}) 140 may be dependant on the target water or humidity level.

In one embodiment, the recirculation pump or blower 220 may be used to achieve the excess fuel ratio (λ_{H2}). The recirculation pump or blower 220 may operate across the entire operating range (current density) of the fuel cell stack 12. The parasitic load of the recirculation pump or blower 220 may be substantial. In one embodiment, a large recirculation pump or blower 220 may be required to provide the power to achieve the target excess fuel ratio (λ_{H2}) 140. In some embodiments the use of the recirculation pump or blower 220 may be inefficient and expensive. The operating characteristics of a recirculation pump or blower 220 may be distinct from the operating conditions of the venturi or ejector 230.

A pressure lift capability of the recirculation pump or blower 220 (ΔP_{_BLWR}) is a function of the flow through the recirculation pump or blower 220 (Q), the blower speed (N), and the density of the flow composition (ρ). The pressure lift of the recirculation pump or blower 220 (ΔP_{_BLWR}) may be limited by power draw limits and/or speed limit of the fuel cell system 10. When the recirculation pump or blower 220 is not spinning or is operating under other fuel cell system 10 stall conditions, the recirculation pump or blower 220 may act as a restriction in the AGR loop 224.

ΔP_{_BLWR}=f(Q, N, ρ) (1)

The fuel cell system 10 may operate under varying operating conditions. Operating conditions may include, but are not limited to operating current density, operating pressure, operating temperature, operating relative humidity, fuel supply pressure, fuel supply temperature, required recirculation flow, entrainment ratio, parasitic load limitations, power needs, pressure loses in the AGR loop 224, venturi or ejector 230 performance and/or efficiency, recirculation pump or blower 220 performance and/or efficiency, fuel density, purge flow, and choked or unchoked (e.g., not choked) flow conditions. The turn down ratio of the fuel cell system 10 is defined as the ratio of the maximum capacity of the venturi or ejector 230 to the minimum capacity of the venturi or ejector 230. The venturi or ejector 230 may draw the recirculation flow 226 using a primary flow exergy. The turn down ratio characterizes the range over which the venturi or ejector 230 can deliver the required excess fuel ratio (λ_{H2}) 140 to the fuel cell stack 12. The fuel cell system 10 may be designed to maximize the venturi or ejector 230 turn down ratio. Consequently, maximizing the turn down ratio of the venturi or ejector 230 also works to minimize the size and parasitic load associated with the recirculation pump or blower 220. In some embodiments, the venturi or ejector 230 may be required to operate and/or perform robustly to deliver the required primary flow 202 at the required excess fuel ratio (λ_{H2}) 140.

In one embodiment, a fuel supply system 80 may supply fuel at a fuel supply pressure (P_{CV}) and a fuel supply temperature (T_{CV}). The primary flow 202 may pass through the control valve 256 and enter the venturi or ejector 230 through a primary nozzle 231 at a primary nozzle inlet pressure (Po) and a primary inlet temperature (T_{O}). The secondary flow 226 may enter the venturi or ejector 230 through a secondary inlet or entrance 232 in a suction chamber 620 at a secondary inlet pressure (P_{S}) and a secondary inlet temperature (T_{S}).

Sizing pressure (P_{_CV_MIN}) may be a minimum inlet pressure at a control valve 256 such as the proportional control valve or mechanical regulator 250 or injector. In other embodiments, fuel sizing pressure (P_{_CV_MIN}) may be the pressure at the inlet of a control valve 256 under empty pressure conditions (P_{EMPTY}). The secondary flow 226 may enter the venturi or ejector 230 through a secondary inlet 232 in a suction chamber 620 at a secondary inlet pressure (P_{S}) and a secondary inlet temperature (T_{S}).

The venturi or ejector 230 may have exergy available in primary flow to induce the anode gas recirculated flow as the secondary flow 226 in the venturi or ejector 230. The stack pressure (ΔP_{STACK}) is the pressure loss through the AGR loop 224. The secondary flow 226 may be lifted against the stack pressure (ΔP_{STACK}).

The pressure lift (ΔP_{LIFT}) is the pressure required to overcome the pressure loses in the AGR loop 224 (ΔP_{STACK}). In some embodiments, the pressure lift (ΔP_{LIFT}) may be dominated by the pressure losses through the fuel cell stack 12 or any other component of the AGR loop 224. In some embodiments, pressure losses may be proportional to volumetric flow rate through one or more manifolds and/or channels in the AGR loop 224. In other embodiments, the volumetric flow 222 at anode inlet 212 may include a mixture of fresh fuel (e.g., H₂) as the primary flow 202 and the recirculation flow 226.

The secondary inlet pressure (P_{S}) may depend on the anode inlet manifold pressure (P_{AIM}) of the fuel cell or fuel cell stack 12 and the pressure loses in the AGR loop 224 (ΔP_{STACK}) or the required pressure lift (ΔP_{LIFT}).

P_{S}=P_{AIM}−ΔP_{LIFT} (2)

The amount of secondary flow 226 that can be entrained is dictated by the boundary conditions of the fuel cell system 10 and the efficiency of the venturi or ejector 230. In some embodiments, the boundary conditions may be the primary nozzle inlet pressure (P_{O}), the secondary inlet pressure (P_{S}), the anode inlet manifold pressure (P_{AIM}) of the fuel cell or fuel cell stack 12, and/or secondary flow 226 composition. In some embodiments, the secondary flow 226 from the anode outlet 214 to the venturi or ejector secondary inlet 232 is an adiabatic process. The primary inlet temperature (T_{O}) and the secondary inlet temperature (T_{S}) of the venturi or ejector 230 may affect secondary flow 226.

As described earlier, above a certain critical current density (i_{_LO_CR}) 130, the fuel cell system 10 is required to operate in the target anode inlet manifold pressure range indicated by the curve 160 in FIG. 2. The primary inlet pressure (P_{O}) may decrease proportionally with primary fuel demand, until the primary nozzle 231 is no longer choked (i.e., unchoked). In other embodiments, if the primary nozzle 231 is unchoked, the rate of decrease of the primary inlet pressure (P_{O}) may be non-linear and/or may be sensitive to downstream pressure such as the secondary inlet pressure (P_{S}). In other embodiments, the primary inlet pressure (P_{O}) may decrease as the primary inlet temperature (T_{O}) decreases.

The primary inlet temperature (T_{O}) may be equal to the fuel supply temperature (T_{CV}). The primary inlet temperature (T_{O}) may affect the primary flow 202. In some embodiments, the fuel cell system 10 may have a target mass flow rate. In other embodiments, the secondary inlet temperature (T_{S}) may influence the secondary flow 226 through geometric constraints of the secondary inlet 232 and/or the venturi or ejector 230. In some embodiments, the secondary inlet temperature (T_{S}) may be a geometric constraint. The thermodynamic constraints and/or venturi or ejector 230 efficiency may also influence the secondary flow 226.

The venturi or ejector 230 may be sensitive to the primary nozzle inlet pressure (P_{O}), the backpressure, and the required pressure lift (ΔP_{LIFT}). The backpressure may be an exit pressure at an ejector exit or outlet 238 (P_{C}) or may be the anode inlet manifold pressure (P_{AIM}). If there are no pressure losses to the anode inlet manifold from the venturi or ejector 230 outlet, the exit pressure at the ejector exit 238 (P_{C}) may be equal to the anode inlet manifold pressure (P_{AIM}). In some embodiment, the primary nozzle inlet pressure (P_{O}) may be a function of the current density (i) in the fuel cell system 10.

P_{O}=f(i) (3)

Entrainment ratio (ER), which is a measure of the performance and/or capability of the venturi or ejector 230 and may be sensitive to the primary nozzle inlet pressure (P_{O}), the backpressure (e.g., P_{C}, P_{AIM}) and/or the pressure lift (ΔP_{LIFT}) In one embodiment, as backpressure (e.g., P_{C}, P_{AIM}) increases, the venturi or ejector 230 may change from being double choked (with a stable entrainment ratio), to being in a transitioning condition (with a decreasing entrainment ratio), to having a reverse flow. Reverse flow in the venturi or ejector 230 may be undesirable as reverse flow indicates no fuel recirculation through the AGR loop 224. In some embodiments, the venturi or ejector 230 may need to offset pressure losses through the fuel cell or fuel cell stack 12 (ΔP_{STACK}), while operating against the backpressure (e.g., P_{C}, P_{AIM}).

Methods or systems that enable the fuel management system to directly measure the excess fuel ratio (λ_{H2}) in the fuel cell system 10 are useful to the performance of the fuel cell system 10. While the direct measurement of the recirculation flow rate, primary flow rate, or entrainment ratio may not be possible, the fuel (e.g., H₂) consumption in the fuel cell system 10 and/or any purge gas flow rate in the fuel cell system 10 may be determined. In some embodiments, the fuel consumption may be based on the operating current density.

A key function of the fuel management system may be to provide an anode gas flow rate with an excess fuel ratio (λ_{H2}) that is above a minimum value. The excess fuel ratio (λ_{H2}) may depend on the flow rate of the primary flow stream 202, the flow rate of the recirculation flow stream 226, and/or the composition of the recirculation flow stream 226. The recirculation flow stream 226 may comprise fuel (e.g., H₂) and water. Alternatively, or additionally, the recirculation flow stream 226 may comprise other gases such as nitrogen (N₂). The excess fuel ratio (λ_{H2}) is calculated as:

λ_{H2}=[(1−x_{_H2O_RC}−x_{_N2_RC})m_{_RC}+m_{_H2_P}]/[m_{_H2_P}] (4)

x_{H2O_RC} is the mass fraction of water in the recirculation flow, x_{_N2_RC} is the mass fraction of nitrogen in the recirculation flow, m_{_RC} is the mass flow rate of the recirculation flow, m_{_H2_P} is the mass flow rate of fuel in the primary flow stream 202.

In one embodiment, the relative flow rates of the recirculation flow stream 226 and the primary flow stream 202 may be considered to determine the entrainment ratio.

ER=[λ_{H2}−1]/[(1−x_{_H2O_RC}−X_{_N2_RC})] (5)

ER=m_{_RC}/m_{_H2_P} (6)

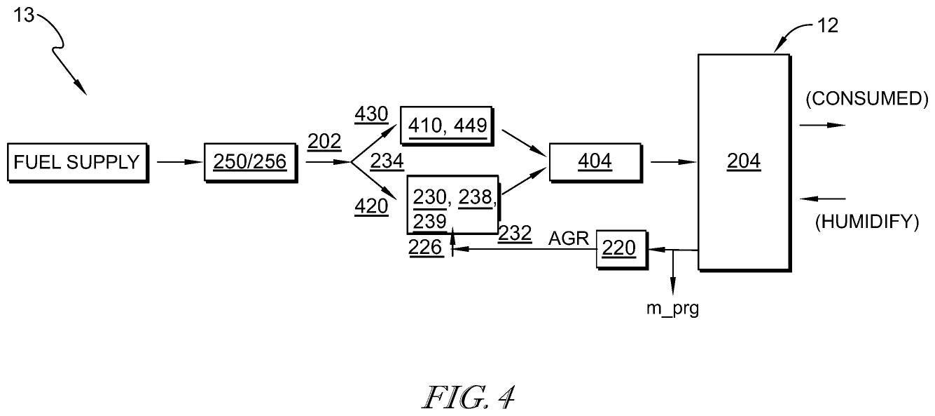

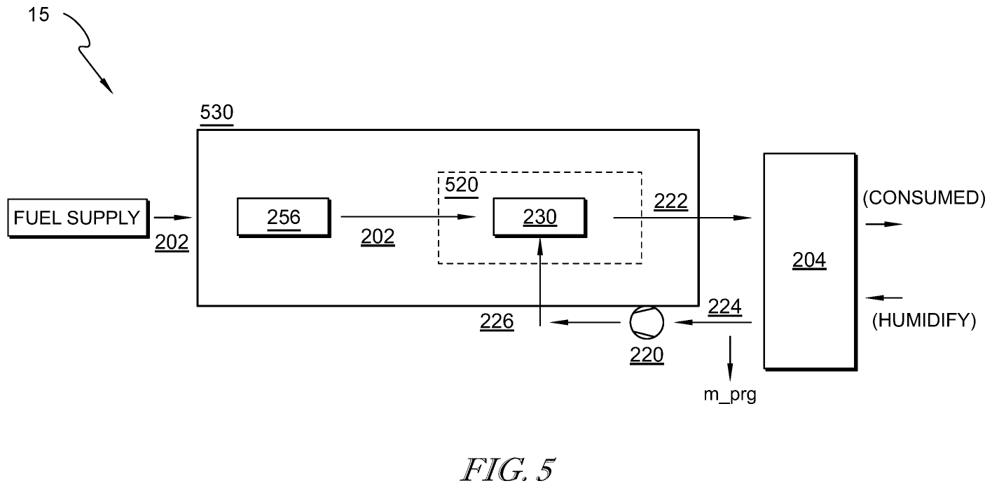

A fuel cell system 13 may be in a configuration as illustrated in FIG. 4. The venturi or ejector 230, sized to support a fraction of primary flow stream 202 (e.g., H₂), may be placed in parallel with a by-pass valve or flow restriction 410. At a minimum, the by-pass valve or flow restriction 410 needs open/close functionality, and must be sized to provide remainder of primary flow stream 202 that does not flow through the venturi or ejector 230. The by-pass valve or flow restriction 410 may be a binary valve with open/close functionality. Alternatively, the by-pass valve or flow restriction 410 may have a variable opening or closing inner valve.

The by-pass valve or flow restriction 410 may be a mechanical regulator, a dome loaded mechanical regulator, an injector, or a proportional control valve. A configuration comprising a by-pass valve or flow restriction 410 may enable anode gas recirculation (AGR) requirements to be met across the entire operating range (from when the fuel cell system 13 is in idle state to when the fuel cell system 13 is functioning in the state of maximum current density).

A configuration comprising a by-pass valve or flow restriction 410 (e.g., a proportional control valve) and an adequately sized venturi or ejector 230 may enable anode gas recirculation (AGR) requirements to be met across the entire operating range (from when the fuel cell system 13 is in idle state to when the fuel cell system 13 is functioning in the state of maximum current density) without requiring a recirculation pump or blower 220. Such a configuration is referred to as the EES (elegant ejector system) configuration.

As shown in FIG. 4, fresh fuel 202 may enter a control valve 256 such as a mechanical regulator 250 at a fuel supply temperature (T_{CV}) and fuel supply pressure (P_{CV}). The fresh fuel 202 may exit the mechanical regulator 250 and enter the venturi or ejector 230 or flow restriction 410 at a primary nozzle inlet pressure (P_{O}) and primary inlet temperature (T_{O}). A certain amount of the fresh fuel 202 exiting the control valve 256 may enter the venturi or ejector 230 (m_{_H2_EP}, 420) at the entrance 234. A certain amount of the fresh fuel 202 exiting the control valve 256 may enter the by-pass valve or flow restriction 410 (m_{_H2_RP}, 430). The anode gas recirculation composition 226 (m_{_RC}) may enter the venturi or ejector 230 at the entrance 232 at a secondary inlet pressure (P_{S}) and secondary inlet temperature (T_{S}). The anode gas recirculation composition 226 (m_{_RC}) may have water with a mass fraction x_{_H2O_RC}. The fuel may enter the anode 204 of the fuel cell stack 12 at the anode inlet manifold 404.

In the illustrated embodiment, there may be two entrainment ratios to consider, the entrainment ratio of the venturi or ejector 230 (ER_{EES}) and the entrainment ratio of the system (ER):

ER_{_EES}=m_{_RC}/m_{_H2_EP} (7)

ER=m_{_RC}/m_{_H2_P} (8)

The by-pass valve or flow restriction 410 may be operated to achieve the excess fuel ratio (λ_{H2}). The by-pass valve or flow restriction 410 may be completely open, completely closed, or may be opened but not completely opened. The opening of the by-pass valve or flow restriction 410 may depend on the excess fuel ratio (λ_{H2}) or the entrainment ratio of the system (ER) or the entrainment ratio of the venturi or ejector 230 (ER_{_EES}).

In one embodiment, the fuel cell system 10/13 may not comprise a venturi or an ejector 230. In some embodiments, the fuel cell system 10/13 may comprise a mixing manifold instead of venturi or an ejector 230. The primary flow stream 202/420 and the recirculation flow stream 226 may mix in the mixing manifold to form the flow stream 222.

The fuel cell system 10/13 may comprise more than one venturi or ejector 230 in a parallel or series configuration. The operation of the more than one venturi or ejector 230 in a parallel or series configuration may be determined based on the entrainment ratio of the system (ER) or the entrainment ratio of the venturi or ejector 230 (ER_{_EES}). Determining the operation of the more than one venturi or ejector 230 in a parallel or series configuration may comprise determining if all or some of the venturi or ejector 230 in a parallel or series configuration are required to operate, and/or determining the order of the operation of the more than one venturi or ejector 230 in a parallel or series configuration.

The excess fuel ratio (λ_{H2}) or the entrainment ratio of the system (ER) or the entrainment ratio of the venturi or ejector 230 (ER_{_EES}) may be determined by using physical or virtual sensing systems or methods. In some embodiments, one or more controller 239 may be used for monitoring and/or controlling the physical or virtual temperature sensors 262 or pressure sensors 263.

In the fuel cell system 10/13, in order to determine when the recirculation pump or blower 220 needs to be used to provide additional support to the venturi or ejector 230, the entrainment ratios (ER, ER_{_EES}) need to be accurately estimated. If the entrainment ratio is estimated, use of the recirculation pump or blower 220 may be initiated when the fuel cell system 10/13 approaches the operating condition where the venturi or ejector 230 is expected to be near its operational limit. The use of the recirculation pump or blower 220 may be initiated when the operating current density is less than about 0.8 A/cm² and/or at the temperatures or pressures associated with a current density less than about 0.8 A/cm².

If the fuel cell system 10/13 is operating under transient conditions, the operating current density for initiating use of the recirculation pump or blower 220 may be different than if the fuel cell system 10/13 is operating at steady state conditions. For example, if the fuel cell system 10/13 is operating at about 0.8 A/cm² under transient conditions, the system may temporarily operate at about 1.5 bara pressure instead of about 2.5 bara pressure and at about 75° C. instead of about 85° C. If the recirculation pump or blower 220 may need to be turned on at about 0.8 A/cm² under steady state conditions, the recirculation pump or blower 220 may need to be initiated at about 1 A/cm² if the fuel cell system 10/13 is operating under transient conditions.

The excess fuel ratio (λ_{H2}) may be estimated and used as feedback to blower controls 229 when the fuel cell system 10/13 is engaging the recirculation pump or blower 220, so that the parasitic load associated with running the recirculation pump or blower 220 may be minimized The excess fuel ratio (λ_{H2}) may be estimated and used as feedback to a blower controller when the system is engaging the recirculation pump or blower 220, so that the speed of the recirculation pump or blower 220 may be altered. The excess fuel ratio (λ_{H2}) may be estimated and used as feedback to a by-pass valve controller 449 or to an ejector controller 239.

In one embodiment, use of physical or virtual sensing systems or methods may result in uncertainty in the measured entrainment ratio (ER). In some embodiments, the physical or virtual sensing systems or methods may comprise temperature sensors 262 and/or pressure sensors 263. To protect for uncertainty in the measured entrainment ratio (ER), the concept of a nominal entrainment ratio (ER_{NOM}) and minimum entrainment ratio (ER_{MIN}) may be used.

ER_{NOM}=ER_{MIN}+Zσ_{_ER} (9)

Z gives a statistical level of confidence that the excess fuel ratio (λ_{H2}) will be above the minimum required excess fuel ratio (λ_{H2}) or at target excess fuel ratio (λ_{H2}) a when the nominal entrainment ratio (ER_{NOM}) is measured for given population standard deviation of σ_{_ER}. If the entrainment ratio (ER) measured is equal to the nominal entrainment ratio (ER_{NOM}), the recirculation pump or blower 220 may need to be used to provide additional support to the venturi or ejector 230. If Z is equal to about 2.05, there would 98% confidence that the excess fuel ratio (λ_{H2}) will be above the minimum required excess fuel ratio (λ_{H2}). The systems and methods used to measure the nominal entrainment ratio (ER_{NOM}) and excess fuel ratio (λ_{H2}) may need to have uncertainty of less than about 12%. The ratio of the standard deviation (σ_{_ER}) to and minimum entrainment ratio (ER_{MIN}) is less than about 12%.

σ_{_ER}/ER_{MIN}≤12% (10)

The mass flow rate (m) of a gas stream may be a function of characteristic pressure loss or pressure differential (ΔP) across the element (e.g., fuel stack 12, recirculation pump or blower 220) through which the gas stream is flowing. In some embodiments, pressure sensors 263 may be used to determine a pressure differential (ΔP) across the element (e.g., fuel stack 12, recirculation pump or blower 220). The calculated pressure differential (ΔP) may be used to determine the flow rates of the primary flow stream 202 and of the recirculation flow stream 226. The density (ρ) of the gas stream may be estimated based on the pressure (P) in the gas stream, the temperature (T) of the gas stream and average gas constant (R) of the gas stream. The gas stream may be the primary flow stream 202 or the recirculation flow stream 226 in the fuel cell system 10/13. The gas stream may be the primary flow stream 420 through the venturi or ejector 230 or the flow stream 430 through the by-pass valve or flow restriction 410, or the recirculation flow stream 226 in the fuel cell system 10/13.

Referring back to FIGS. 3 and 4,

m_{_AIM}=f(ΔP_{STACK}, ρ_{_AIM}) (11)

m_{_AIM} is the mass flow rate at the anode inlet manifold 404 or anode inlet 212 of the fuel cell system 10/13. m_{_AIM_TARGET} is the target mass flow rate at the anode inlet manifold 404 or anode inlet 212 of the fuel cell system 10/13. ρ_{AIM} is the density of the gas stream at the anode inlet manifold 404 or anode inlet 212.

The mass flow rate of fuel in the primary flow stream 202/420 (m_{_H2_P}, m_{_H2_EP}) into the inlet of the ejector 230 may be estimated based on the operating current density, the primary nozzle inlet pressure (P_{O}), and/or primary nozzle inlet temperature (T_{O}). The mass fraction of water in the recirculation flow (x_{_H2O_RC}) may be estimated based on the fuel cell stack 12 outlet pressure, fuel cell stack 12 outlet temperature and/or the relative humidity in the recirculation flow stream 226. In other embodiments, the mass fraction of nitrogen in the recirculation flow (x_{_N2_RC}) may be a fixed value or may be estimated based on the time since the last purge event. The entrainment ratio (ER) may be determined as:

ER+1=m_{_AIM}/m_{_H2_P} (12)

In one embodiment, the target mass flow rate at the anode inlet manifold 404 or anode inlet 212 (m_{_AIM_TARGET}) may be a function of other parameters that are equivalent to the primary flow stream 202/420 (m_{_H2_P}, m_{_H2_EP}) or to the fuel consumption rate, such as operating current density.

m_{_AIM_TARGET}=f(m_{H2_P}) (13)

When the mass flow rate at the anode inlet manifold 404 or anode inlet 212 (m_{_AIM}) is less than the target mass flow rate at the anode inlet manifold 404 or anode inlet 212 (m_{_AIM_TARGET}), the fuel cell system 10/13 may initiate the use of the recirculation pump or blower 220. When the fuel cell system 10/13 initiates the use of the recirculation pump or blower 220, the fuel cell system 10/13 may be in a boosted by blower state. When the fuel cell system 10/13 is in the boosted by blower state, the fuel cell system 10/13 may adjust the speed of the recirculation pump or blower 220 such that the anode inlet manifold 404 or anode inlet 212 (m_{_AIM}) is greater than the target mass flow rate at the anode inlet manifold 404 or anode inlet 212 (m_{_AIM_TARGET}).

A controller 459 may control the mass flow rate at the anode inlet manifold 404 or anode inlet 212 (m_{_AIM}). In some embodiments, the controller 459 may determine the mass flow rate at the anode inlet manifold 404 or anode inlet 212 (m_{_AIM}) to be a function of the mass flow rate of fuel in the primary flow stream 202/420 (m_{_H2_P}, m_{_H2_EP}) into the inlet of the ejector 230.

The mass flow rate at the anode inlet manifold 404 or anode inlet 212 (m_{_AIM}) may be determined as:

Vdot_{_AIM}=A_{_AIM}×ΔP_{AIM} (14)

m_{_AIM}=Vdot_{_AIM}×ρ_{AIM} (15)

A_{_AIM}=f(P_{AIM}, T_{AIM}, i_{_AIM}) (16)

Vdot_{_AIM} is the volumetric flow rate at anode manifold inlet of the fuel cell system 10/13, A_{_AIM} is a transfer function, ΔP_{AIM} is the pressure differential across the anode inlet manifold 404 or anode inlet 212.

The correlation for the transfer function (A_{_AIM}) may be developed for nominal steady state operating conditions at an operating current density (i_{_AIM}). In some embodiments, additional fidelity may be added to correct for off-nominal conditions such as transient conditions. The additional fidelity may be achieved by using a modified transfer function under highly transient conditions, where the modified transfer function accounts for the system dynamics.

The uncertainty associated with the volumetric flow rate at anode manifold inlet (Vdot_{_AIM}) of the fuel cell system 10/13 may be dominated by the ability to measure the pressure differential across the anode inlet manifold 404 or anode inlet 212 (ΔP_{AIM}). The transfer function (A_{_AIM}) may be linear and uncorrelated to the pressure differential across the anode inlet manifold 404 or anode inlet 212 (ΔP_{AIM}).

The uncertainty associated with pressure sensors 263 may depend on the use of single point pressure sensors 265 or differential pressure sensors 267. In one embodiment, absolute pressure sensors 269 may be used at the air side and at the cathode side. The target bias pressure (P_{BIAS}) and/or thresholds associated with standard errors may vary with operating conditions. The target bias pressure (P_{BIAS}) and/or thresholds associated with standard errors may be a function of gross current and/or current density of the fuel cell system 10/13.

Inaccurate pressure measurements at the anode 204 and the cathode 208 may result in error propagation. In one embodiment, single point pressure sensors 265 may be used at the anode inlet 212 and/or the cathode inlet 216. For example, if single point pressure sensors 265, such as an anode side pressure sensor and a cathode side pressure sensor, are used to measure the pressure at the anode inlet 212 (P1) and cathode inlet 216 (P2), the pressure differential (ΔP) across the anode 204 and the cathode 208 is determined as follows and further described in Table 1.

ΔP=P1−P2=P_{AIM}−P_{_CATHODE} (17)

TABLE 1

| | | | | one | | standard error (one | |
|---|---|---|---|---|---|---|---|
| | | | | sigma | | sigma) | |
| P1 = | 2.50 | [bara] | Xₚ₁ = | 2.4% | | 0.06 | [bara] |
| P2 = | 2.25 | [bara] | Xₚ₂ = | 2.7% | | 0.06 | [bara] |
| ΔP = | 0.25 | [bara] | σ_{ΔP} = | 0.085 | [bara] | | |

The uncertainty is about 2% of a full scale pressure of 3.0 bara. Since the pressures measured (e.g., P1 and P2) are less than the full scale of 3.0 bara (e.g., 2.5 bara and 2.25 bara), the uncertainty is higher than 2% (e.g., 2.4% and 2.7%). As shown in Table 1, even if the single point pressure sensors 265 are relatively accurate, error propagation impacts the accurate measurement of the pressure differential (ΔP). In this instance, the single point standard error is 0.085 bara. Thus, there may be about a 34% error in the measurement of the pressure differential (ΔP).

Such error in measuring the single point pressures at the anode 204 (e.g., at the anode inlet 212) and the cathode 208 (e.g., at the anode inlet 216), and hence the error in accurately determining the pressure differential (ΔP) between the anode 204 side and the cathode 208 side, could exist from the beginning of use of the fuel cell stack 12 comprising the anode 204 and the cathode 208. Alternatively, the error in measuring the single point pressures at the anode 204 (e.g., at the anode inlet 212) and the cathode 208 (e.g., at the cathode inlet 216) may occur with pressure sensor 263 aging and/or drift over time.

If the error in the pressure measurements, as described in the example above is about 34%,

(σ_Vdot_{_AIM})/(Vdot_{_AIM})=(σ_ΔP_{_AIM})/(ΔP_{_AIM})=34% (18)

In one embodiment,

ρ_{_AIM}=P_{AIM}/(R_{_AIM}×T_{AIM}) (19)

R_{_AIM} is the gas constant in the anode inlet manifold 404 or anode inlet 212, ρ_{_AIM} is the density in the anode inlet manifold 404 or anode inlet 212, T_{AIM} is the temperature in the anode inlet manifold 404 or anode inlet 212.

The error associated with the molecular weight of the of the gas stream in the anode inlet manifold 404 or anode inlet 212 (σ_{_MW}) depends on the error associated with the mole fraction of hydrogen in the gas stream at the anode inlet manifold 404 or anode inlet 212 (σ_{_Y_H2}), the molecular weight of hydrogen (MW_{_H2}) is about 2.0156 g/mole, and the molecular weight of water (MW_{_H2O}) is about 18.105. If the error associated with the mole fraction of hydrogen in the gas stream at the anode inlet manifold 404 or anode inlet 212 (σ_{_Y_H2}) is about 0.02, the error associated with the molecular weight of the of the gas stream in the anode inlet manifold 404 or anode inlet 212 (σ_{_MW}) is:

σ_{_MW}=σ_{_Y_H2}(MW_{_H2O}−MW_{_H2})=0.32 (20)

If the nominal molecular weight (MW_{_AIM_NOM}) is about 10, the error associated with the universal gas constant in the anode inlet manifold 404 or anode inlet 212 (σ_{_R_AIM}) is:

σ_{_R_AIM}/R_{_AIM}=σ_MW/MW_{_AIM}=3.2% (21)

MW_{_AIM} is the molecular weight of the gas stream in the anode inlet manifold 404 or anode inlet 212.

The nominal molecular weight of the gas stream at the anode inlet manifold 404 or anode inlet 212 (MW_{_AIM_NOM}) is:

MW_{_AIM_NOM}=y_{_H2_AIM}×(MW_{_H2}−MW_{_H2O})+MW_{_H2O} (22)

y_{_H2_AIM} is the mole fraction of hydrogen in the gas stream at the anode inlet manifold 404 or anode inlet 212.

The error associated with determining the density in the anode inlet manifold 404 or anode inlet 212 (σ_{_p_AIM}) depends on the error associated with the universal gas constant in the anode inlet manifold (σ_{_R_AIM}), the error associated with the pressure in the anode inlet manifold 404 or anode inlet 212 (σ_{_P_AIM}), and the error associated with the temperature in the anode inlet manifold 404 or anode inlet 212 (σ_{_T_AIM}).

σ_{_p_AIM}/ρ_{_AIM}=4% (23)

σ_{m_AIM}/m_{_AIM}=34% (24)

ER+1=m_{_AIM}/m_{_H2_P} (25)

If the nominal mole fraction of hydrogen in the gas stream at anode inlet manifold 404 or anode inlet 212 (y_{_H2_AIM_NOM}) is about 0.5, and the error associated with the nominal mole fraction of hydrogen in the gas stream at anode inlet manifold 404 or anode inlet 212 (σ_{_Y_H2}) is about 0.02, the ER is equal to about 2, and the error associated with determining the ER is σ_{_ER},

σ_{_ER}/ER=52% (26)

In one embodiment, an alternate method may be used to calculate or determine the entrainment ratio (ER) from the mass flow rate through the anode inlet manifold 404 or anode inlet 212 (m_{AIM}).

ER+1=m_{_AIM}/m_{_H2_P} (27)

ER=[λ_{H2}−1]/[(1−x_{_H2O_RC}−x_{_N2_RC})] (28)

There may be additional error propagation if this method is used to determine the entrainment ratio (ER). For example, considering an uncertainty greater than about 50% in the determination of the mass flow rate through the anode inlet manifold 404 or anode inlet 212 (m_{_AIM}),

σ_{_ER}/ER>50%×(ER+1)/ER (29)

If ER=2, σ_{_ER}/ER>75% (30)

Using the pressure differential (ΔP) across the anode 204 and the cathode 208 depends on highly accurate pressure measurements. In some embodiments, to ensure an uncertainty of 12% or less in the measurements of the nominal entrainment ratio (ER_{NOM}) and excess fuel ratio (λ_{H2}), the pressure differential (ΔP) measurement may need an uncertainty of less than about 10. The absolute pressure sensors 269 may need an uncertainty of less than 0.5%. In a preferential embodiment, pressure differential sensors 267 may be used instead of absolute pressure 269 sensors.

One or more pressure differential sensors 267 that measure the pressure difference between two or more locations in the anode recirculation loop 224 may be used in addition to or instead of the single point pressure sensors 265 at the anode 204 and the cathode 208. The pressure differential sensor 267 may be designed to control recirculation flow stream 226 in the anode recirculation loop 224.

The differential pressure sensor 267 with an uncertainty of less than about 10% is required such that the blower controller may be able to determine when operate the recirculation pump or blower 220 or the speed at which to operate the recirculation pump or blower 220. Alternatively, or additionally, the differential pressure sensor 267 with an uncertainty of less than about 10% is required such that the by-pass valve controller may be able to determine the operation of the by-pass valve or flow restriction 410.

Alternatively, or additionally, the differential pressure sensor 267 with an uncertainty of less than about 10% is required such that the ejector controller may be able to determine when operation of one or more venturi or ejectors 230. The pressure differential sensors 267 may have an uncertainty of about 0.3% to about 0.5%, about 0.5% to about 1%, about 1% to about 5%, or about 5% to about 10%, including any percentage or range comprised therein.

The pressure sensors 263 may be calibrated in-situ. The flow rate may be estimated based on calibrated pressure sensors. The pressure sensors 263 may be used to measure the pressure differential (ΔP) under conditions where the primary flow stream 202/420 and entrained mass flow 226 rates are known, the pressure sensors 263 may be calibrated to the known flow rates, and then used to make future measurements. The pressure sensor 263 measurements may be compared to an expected measurement under the known operating conditions, any offset may be recorded and used to correct future measurements.

The pressure sensors 263 may be used to measure the pressure differential (ΔP) under steady state conditions at high operating current density when the venturi or ejector 230 is operating under geometrically constrained conditions. The pressure sensors 263 may be used to measure the pressure differential (ΔP) under steady state conditions at low operating current density when the recirculation pump or blower 220 is operating at a known speed. In each of the known conditions, a relative offset in the pressure differential (ΔP) may be recorded and used to correct any future measurements made with the same pressure sensors 263. In some embodiments, the pressure differential (ΔP) may be compared to an expected measurement under the known operating conditions, any offset may be recorded and used to correct future measurements.

The target mass flow rate at the anode inlet manifold 404 or anode inlet 212 of the system (m_{_AIM_TARGET}) may be estimated or developed based on the amount of the fresh fuel 202 that enters the venturi or ejector 230 at the entrance 234 in the fuel cell system 10/13. The target mass flow rate (m_{_AIM_TARGET}) at the anode inlet manifold 404 or anode inlet 212 of the fuel cell system 10/13 may be estimated or developed based on the amount of the fresh fuel 320 that enters the venturi or ejector 230 at the entrance 234 in the fuel cell system 10/13.

The mass flow rate the fresh fuel 202, 420 may be estimated from the pressure differential (ΔP) and may be used to determine when the recirculation pump or blower 220 may be turned on and/or if the speed of the recirculation pump or blower 220 needs to be adjusted In some embodiments, if the uncertainty in the entrainment calculation is more than about 12% or if the differential pressure sensor 267 with an uncertainty of more than about 10%, the flow rate estimated from the pressure differential (ΔP) may be used by one or more controller(s) such as the blower controller 229, the by-pass valve controller 449, or the ejector controller 239 as a diagnostic tool. In some embodiments, the blower controller 229, the by-pass valve controller 449, or the ejector controller 239 may be the same.

In one embodiment, the entrainment ratio (ER) may be determined based on the temperature at the mixing points of different gas streams in the fuel cell system 10/13. Under steady state conditions and with no heat loss, ER is:

ER=−C_{P_A}66 T_{A}/C_{P_B}ΔT_{B} (31)

C_{P_A} is the specific heat at constant pressure of the primary flow stream 202/420, ΔT_{A} is the change in temperature of the primary flow stream 202/420 before and after mixing, C_{P_B} is the specific heat at constant pressure of the recirculation flow stream 226, and ΔT_{B} is the change in temperature of the recirculation flow stream 226 before and after mixing.

The entrainment ratio (ER) or the excess fuel ratio may be determined by estimating the average heat capacity of the primary flow stream 202/420 and the average heat capacity of the recirculation flow stream 226. The primary flow stream 202 and the recirculation flow stream 226 in the fuel cell system 10/13 may undergo adiabatic mixing. In some embodiments, as illustrated in FIG. 5, a fuel cell system 15 may comprise an energy balance around box 520, where the flow streams 202 and 226 mix to form the flow stream 222. In other embodiments, the fuel cell system may comprise an energy balance around box 530, where the flow streams 202 and 226 mix to form the flow stream 222. Physical or virtual temperature sensors 262 may be used to make temperature measurements around the mixing points.

If the energy balance is comprised across box 520, ΔT_{A} is the change in temperature of the primary flow stream 202 across the venturi or ejector 230, C_{P_B} is the specific heat at constant pressure of the recirculation flow stream 226, and ΔT_{B} is the change in temperature of the recirculation flow stream 226 across the venturi or ejector 230. The venturi or ejector 230 acts as the mixing point. If the energy balance is comprised across box 530, ΔT_{A} is the change in temperature of the primary flow stream 202 across the mechanical valve 250 and the venturi or ejector 230. C_{P_B} is the specific heat at constant pressure of the recirculation flow stream 226, and ΔT_{B} is the change in temperature of the recirculation flow stream 226 across the venturi or ejector 230. The mechanical valve 250 and the venturi or ejector 230 acts as the mixing point. In some embodiments, there may be minimal temperature loss in the primary flow stream 202 across the mechanical valve 250. Thus, since the flow through the mechanical regulator 250 may be isothermal, the same energy balance may be used around boxes 520 and 530. A correction term may be added to account for heat losses based on temperature difference between the surface of the venturi or ejector 230 and environmental temperature around the venturi or ejector 230.

In one embodiment, if the energy balance around box 520/530 may be assumed to adiabatic and be determined as:

m_{_A}×h_{_A_I}+m_{_B}×h_{_B_I}=m_{_C}×h_{_C_O} (32)

m_{_A} is the mass flow rate of the primary flow stream 202, h_{_A_I} is the enthalpy of the primary flow stream 202 at the inlet 234 of the venturi or ejector 230, m_{_B} is the mass flow rate of the recirculation flow stream 226, h_{_B_I} is the enthalpy of the recirculation flow stream 226 at the inlet 232 of the venturi or ejector 230, m_{_C} is the mass flow rate of the flow stream 222 exiting the venturi or ejector 230, h_{_C_O} is the enthalpy of the flow stream 222 at the exit 238 of the venturi or ejector 230. Assuming the enthalpy of mixing is zero,

m_{_A}×h_{_A_I}+m_{_B}×h_{_B_I}=m_{_A}×h_{_A_O}+m_{_B}×h_{_B_O} (33)

h_{_A_O} is the enthalpy of the primary flow stream 202 at the exit 238 of the venturi or ejector 230, h_{_B_O} is the enthalpy of the recirculation flow stream 226 at the exit 238 of the venturi or ejector 230.

The entrainment ratio (ER) is:

ER=m_{_A}/m_{_B}=−(h_{_A_O}−h_{_A_I})/(h_{_B_O}−h_{_B_I}) (34)

The primary flow 202 may be pure hydrogen, and the enthalpy at the inlet (h_{_A_I}) and outlet (h_{_A_O}) may be determined using a look-up table and/or equation. Alternatively, the primary flow 202 may be pure hydrogen, and the enthalpy at the inlet (h_{_A_I}) and outlet (h_{_A_O}) may be determined based on the temperature of the primary flow at the inlet (T_{A_I}), temperature of the primary flow at the outlet (T_{A_O}), pressure of the primary flow at the inlet (P_{A_I}), and/or pressure of the primary flow at the outlet (P_{A_O}). In some other embodiments, other variables sufficient to determine the thermodynamic state of the closed system or enclosure being considered. The closed system or enclosure may be the described by box 520, box 530 or a different enclosure.

The primary flow stream 202 may experience a significant pressure drop through the closed system or enclosure being considered. The static and stagnation temperature may be assumed to be similar. A low flow velocity, with a Mach number less than 0.1 may be assumed. In some embodiments, for the range of inlet and outlet pressures and temperatures, constant heat capacity may be assumed for the primary flow stream 202.

ER=−C_{P_A}ΔT_{A}/Δh_{_B} (35)

Δh_{_B} is the change in enthalpy of the recirculation flow stream 226 stream.

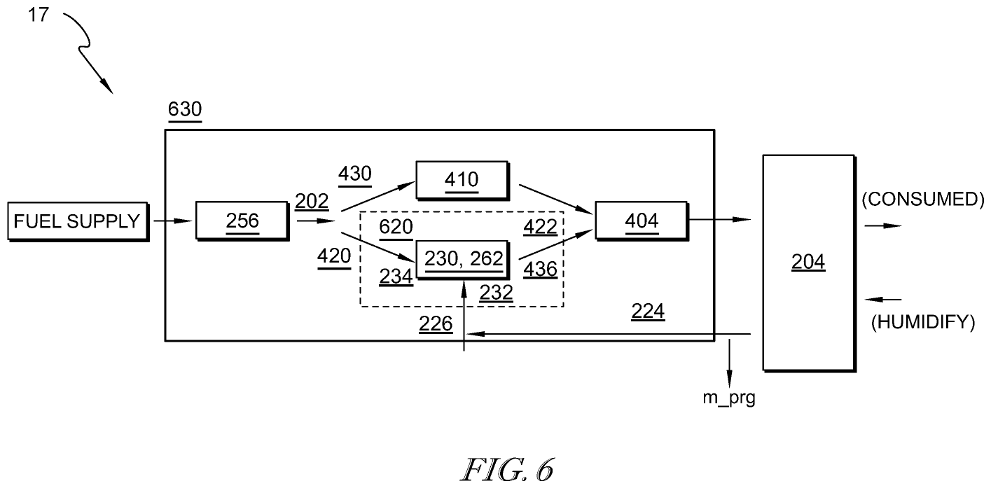

A similar energy balance may be implemented in a fuel cell system 17 comprising a venturi or ejector 230, sized to support a fraction of primary flow stream 202 (e.g., H₂), placed in parallel with a by-pass valve or flow restriction 410, as shown in FIG. 6. If the energy balance is comprised across box 620, ΔT_{A} is the change in temperature of the primary flow stream 420 across the venturi or ejector 230, C_{P_B} is the specific heat at constant pressure of the recirculation flow stream 226, and ΔT_{B} is the change in temperature of the recirculation flow stream 226 across the venturi or ejector 230. The venturi or ejector 230 acts as the mixing point, and flow stream 436 enters the anode inlet manifold 404. Physical or virtual temperature sensors 262 may be used to make temperature measurements around the mixing point.

If the energy balance is comprised across box 630, ΔT_{A} is the change in temperature of the primary flow stream 202 across the mechanical valve 250, the by-pass valve or flow restriction 410, and the venturi or ejector 230. C_{P_B} is the specific heat at constant pressure of the recirculation flow stream 226, and ΔT_{B} is the change in temperature of the recirculation flow stream 226 across the venturi or ejector 230. The mechanical valve 250, the by-pass valve or flow restriction 410, the venturi or ejector 230, and the anode inlet manifold 404 act as the mixing point and flow streams 436, 422 enters the anode inlet manifold 404. . In some embodiments, there may be minimal temperature loss in the primary flow stream 202 across the mechanical valve 250 and there may be minimal temperature loss in the primary flow stream 430 across the by-pass valve or flow restriction 410.

The recirculation flow stream 226 may be a multi-component stream hydrogen (H₂), water (H₂O) and/other contaminants (e.g., N₂). Since the properties of hydrogen and water are substantially different, the change in enthalpy may need to account for the composition of the recirculation flow stream 226.

The composition of the recirculation flow stream 226 may be estimated by estimating the relative humidity of the recirculation flow stream 226 based on the upstream component, i.e. the fuel cell stack 12. For example, the relative humidity of the stream exiting the anode side 214 of the fuel cell stack 12 may be estimated from a look-up table based on operating conditions. In some embodiments, the relative humidity at the anode outlet (RH_{ANODE_O}) 214 may be 1.0. The saturated vapor pressure of water (P_{SAT_H2O}) may need to be estimated to determine the composition of the recirculation flow stream 226. The saturated vapor pressure of water (P_{SAT_H2O}) depends on temperature, and may be obtained from a look-up table or an equation (e.g., Antoine equation).

If the saturated vapor pressure of water (P_{SAT_H2O}) is known, the water molar fraction in the recirculation flow (y_{H2O_RC}) is:

y_{_H2O_RC}=(RH_{ANODE_O}×P_{SAT_H2O})/P_{ANODE_O} (36)

P_{ANODE_O} is the pressure at the anode outlet 214.

If the recirculation flow stream 226 comprises hydrogen, water and nitrogen, the hydrogen molar fraction in the recirculation flow stream 226 (y_{_H2O_RC}) is:

y_{_H2_RC}=1−y_{_H2O_RC}−y_{_N2_RC} (37)

y_{_N2_RC} is the nitrogen molar fraction in the recirculation flow stream 226, and may need to be estimated. Nitrogen (N₂) may be a representative contaminant in the anode recirculation loop 224. The anode recirculation loop 224 may comprise additional or fewer contaminants In some embodiments, nitrogen (N₂) may be the largest contaminant as it may diffuse across the MEA from the cathode side into anode side. In other embodiments, other contaminants present in the fuel may also accumulate in the anode recirculation loop 224. The other contaminants may be in lower concentration than nitrogen (N₂) as fresh hydrogen fuel purity requirements are high.

The nitrogen molar fraction in the recirculation flow stream 226 may be estimated. In some embodiments, the nitrogen molar fraction in the recirculation flow stream 226, and may be estimated based on a model that estimates the diffusion rate of nitrogen across a membrane in the fuel cell stack 12 and may be based on stack operating conditions. In other embodiments, nitrogen purge may be estimated based on the gas purging rates. The net nitrogen in the recirculation and the nitrogen mole fraction may be estimated based on volume, temperature, and pressure within the anode system.

The nitrogen molar fraction in the recirculation flow stream 226 (y_{_N2_RC}) may be set to a fixed value. Alternatively, or additionally, the nitrogen molar fraction in the recirculation flow stream 226 (y_{_N2_RC}) may be set to zero, if the net rate of nitrogen (N₂) diffusion from the cathode side to the anode side is expected to be low compared to the gas purging rate. Alternatively, or additionally, the nitrogen molar fraction in the recirculation flow stream 226 (y_{_N2_RC}) may be set to a fixed high value if it may be desirable to make a conservative estimate of the excess fuel ratio (λ_{H2}).

The mass fraction (x_{_K}) of the different components of the recirculation flow stream 226 may be determined based on the mole fraction of the different components.

MW_{_B}=Σy_{_K}×MW_{_K}(_{K} is H₂O, H₂, N₂) (38)

x_{_K}=y_{_K}×MW_{_K} (39)

MW_{_K} is the molecular weight of the different components of the recirculation flow stream 226. MW_{_B} is the molecular weight of the recirculation flow stream 226.

In some embodiments, other systems or methods may be used to determine the composition of the recirculation flow stream 226. The other systems and/or methods may include but are not limited to humidity sensors and/or other analyzers may be used to determine the composition of the recirculation flow stream 226.

After the composition of the recirculation flow stream 226, the enthalpy change in the composition of the recirculation flow stream 226 may be estimated using the method similar to the one described above for pure hydrogen in the primary flow stream 202/420. In some embodiments, for the range of inlet and outlet pressures and temperatures, constant heat capacity may be assumed for the recirculation flow stream 226.

C_{P_B}=Σx_{_K}×C_{P_K}(_{K} is H₂O, H₂, N₂) (40)

R_{_B}=R_{UGS}/MW_{_B} (41)

Δh_{_B}=C_{P_B}×(T_{B_O}−T_{B_I}) (42)

R_{UGS} is the universal gas constant. In one embodiment, if the closed enclosure being considered is 292, T_{B_I} is the temperature of the recirculation flow stream 226 at the inlet 232 and T_{B_O} is temperature of the recirculation flow stream 226 at the exit 238.

The rate of change of primary fuel supply temperature (T_{CV}) may be determined by ambient conditions, which may vary slowly compared to the thermal dynamics of the venturi or ejector 230. In some embodiments, if the fuel supply temperature (T_{CV}) is pre-conditioned, the rate of change of primary fuel supply temperature (T_{CV}) may decrease. It may be preferable to maximize the temperature change of the primary flow stream 202/420 in the venturi or ejector 230. The design configurations may enable the maximizing of the temperature change of the primary flow stream 202/420 in the venturi or ejector 230. The primary flow stream 202/420 may be pre-conditioned by a low temperature coolant (e.g., coolant at a temperature below about 50° C.). The temperature of the recirculation flow stream 226 may be equal to the coolant inlet temperature. The coolant inlet temperature may be about 5° C. to 10° C. lower than the target cathode outlet operating temperature of about 70° C. to about 80° C. The fuel cell 20 or fuel cell stack 12 may be configured such that anode gas stream co-flows with the coolant such that there is higher change in temperature across the flow streams.

The rate of change of the inlet temperature of the recirculation flow stream 226 (T_{B_IN}) may be controlled by the fuel cell stack anode outlet 214 temperature. The dynamics of change in primary fuel supply temperature (T_{CV}) may be slow compared to the thermal dynamics of the venturi or ejector 230. The estimation based on steady state adiabatic analysis may be sufficient to estimate the entrainment ratio (ER).

The approach described above may be implemented for fuel cell systems 10, 13, 15, 17 used in range extender applications, with pseudo-steady state operation, i.e. instances when operating conditions vary slowly such that dynamic effects are low. Effect of heat losses and transient behavior may be required to be implemented to estimate the entrainment ratio (ER). The venturi or ejector 230 may be insulated or may employ a heat shield to prevent heat loss.

In one embodiment, a correction term may be used to account for the effect of heat loss to the environment.

0=m_{_A}C_{P_A}ΔT_{A}+m_{_B}C_{P_B}ΔT_{B}+Q2A (43)

Q2A=UA(T_{EJJ}−T_{AMB}) (44)

Q is the heat transferred to the venturi or ejector 230, U is the heat transfer coefficient, A is the effective area of the venturi or ejector 230, T_{EJJ} is the temperature of the venturi or ejector 230, T_{AMB} is the ambient temperature.

ER=−C_{P_A}ΔT_{A}/C_{P_B}ΔT_{B}−UAΔT_{AMB}/m_{_A}C_{P_B}ΔT_{B} (45)

UA ΔT_{AMB}/m_{_A} C_{P_B}ΔT_{B} is the correction term.

The entrainment ratio is determined to be a sum of the nominal entrainment ratio (ER_{_NOM}) and a entrainment ratio correction (ER_{CORR}),

ER−ER_{_NOM}+ER_{_CORR} (46)

ER_{_CORR}=(UA/m_{_A}C_{P_B})×((T_{EJJ}−T_{AMB})/(T_{C}−T_{B}) (47)

ER_{_CORR}=f(m_{_A}, C_{P_B}, T_{C}, T_{A}, T_{B} T_{AMB}, UA) (48)

T_{A} is the temperature of the primary flow stream 202, 420 at the venturi or ejector 230 inlet 234, T_{B} is the temperature of the recirculation flow stream 226 at the venturi or ejector 230 inlet 232, T_{C} is the temperature of the gas stream at the venturi or ejector 230 exit 238. The entrainment ratio correction (ER_{_CORR}) may be calibrated a priori against one or more of the parameters that it depends on. The factor UA/m_{_A}C_{P_B} may be estimated using correlation for the heat transfer coefficient (U). Effective external surface area of the venturi or ejector 230 for heat transfer (A) may be calculated based on the dimensions of the venturi or ejector 230. The mass of the primary flow stream 220/420 (m_{_A}) and the effective heat capacity of the recirculation flow stream 226 (C_{P_B}) may be determined as described above.

UA/m_{_A}C_{P_B} may be estimated for a given operating current density. In some embodiments, the temperature ratio may be estimated. If the ambient temperature (T_{AMB}) is about the same as the temperature of the recirculation flow stream 226 (T_{B}), and the temperature of the venturi or ejector 230 (T_{EJJ}) is about the same as the temperature of the gas stream at the venturi or ejector 230 exit 238 (T_{C}),

(T_{EJJ}−T_{AMB)/(}T_{C}−T_{B})˜(T_{C}−T_{B})/(T_{C}−T_{B})=1 (49)

ER_{_CORR}=(UA/m_{_A} C_{P_B})×1 (50)

If for the heat transfer coefficient (U), for free convection is about 10 W/m²/K, and UA/m_{_A} C_{P_B} is determined to be about 0.0001 for a load fraction of about 0.20, the entrainment ratio correction (ER_{_CORR}) may be about 0.0001. If the entrainment ratio correction (ER_{_CORR}) is about 0.0001, the entrainment ratio correction (ER_{_CORR}) may be within the uncertainty range of temperature sensors 262. In some embodiments, under normal operating conditions where there is no forced convection over the venturi or ejector 230, the need to correct for losses to the ambient may be low.

In one embodiment, under a cold start condition, the ambient temperature (T_{AMB}) may be about 0° C. If the temperature of the gas stream at the venturi or ejector 230 exit 238 (T_{C}) is about 85° C., and the temperature of the recirculation flow stream 226 (T_{B}) is about 60° C.,

(T_{EJJ}−T_{AMB})/(T_{C}−T_{B})=(85−0)/(85−60)˜3.4 (51)

If UA/m_{_A} C_{P_B} a is determined to be about 0.0001 for a load fraction of about 0.20, the entrainment ratio correction (ER_{_CORR}) may be about 0.0001×3.4˜0.005. If the entrainment ratio correction (ER_{_CORR}) is about 0.005, the entrainment ratio correction (ER_{_CORR}) may be within the uncertainty range of temperature sensors 262.

In one embodiment, if the fuel cell system 10/13 is operating under transient conditions, the steady state calibration/correction described above may be estimated for the transient response because any difference due to the system operating under transient conditions may be minimal. In other embodiments, a dynamic model that accounts for the transient operation and incorporates the heat capacity of the different components, the mass flow rates of the different flow streams, the heat capacity of the different fluids, heat transfer coefficients, and/or available volume with the venturi or ejector 230 may be implemented.

In one embodiment, the transient model may be a first order approximation. In some embodiments, the transient model may be a second order approximation. In some other embodiments, the transient model may be a simplified first order approximation that may be implemented because a single time constant may dominate the dynamics. In some embodiments any physical or virtual sensors 262, 263 used to measure pressure or temperature may be specified so that the dynamics associated with the sensors 262, 263 are faster than the transient dynamics of the fuel cell system 10/13.

In one embodiment, the uncertainty associated with the temperature sensors 262 may need to less than about 2° C. to determine a usable estimate of the entrainment ratio (ER). The normalized temperature sensor uncertainty is the absolute uncertainty divided by the expected change in temperature across the mixing point. In some embodiments, the absolute uncertainty associated with the temperature measurements may need to be less than about 0.5° C. to ensure that the normalized temperature sensor uncertainty in the estimation of the entrainment ratio is less than about 12%. In some embodiments, the normalized temperature sensor uncertainty may range from about 0.3% to about 0.5%, from about 0.5% to about 1%, from about 1% to about 5%, or from about 5% to about 10%, including any percentage or range comprised therein.

In one embodiment, if the uncertainty in the entrainment calculation is more than about 12% or if the uncertainty associated with the temperature sensors 262 is more than about 0.5° C., the method of determining the entrainment ratio (ER) based on the temperature mixing of different gas streams in the fuel cell system 10/13 may be used by one or more controller(s) such as the blower controller 229, the by-pass valve controller 449, or the ejector controller 239 as a diagnostic tool. In some embodiments, the blower controller 229, the by-pass valve controller 449, or the ejector controller 239 may be the same.

Model based methods may be used to estimate the entrainment ratio (ER) and to determine the nominal speed of the recirculation pump or blower 220. Ejector models (ER_{_EJC_MODEL}) and/or blower models (ER_{_BLW_MODEL}) may be used to estimate the nominal performance of the venturi or ejector 230 and recirculation pump or blower 220 respectively.

Blower models (ER_{_BLW_MODEL}) may be developed to determine open loop speed targets for the recirculation pump or blower 220 used in the fuel cell system 10/13. Blower models (ER_{_BLW_MODEL}) may be used in feedback loops based on different measured parameters.

Amodel of the venturi or ejector 230 (ER_{_EJC_MODEL}) may be used to estimate the capability of the venturi or ejector 230 at a given operating condition. When the entrainment ratio (ER) predicted by the venturi or ejector 230 (ER_{_EIC_MODEL}) is less that the nominal entrainment ratio (ER_{NOM}), the fuel cell system 10/13 may initiate the recirculation pump or blower 220 and transition to a boosted by blower state.

The pressure lift capability of the venturi or ejector 230 (ΔP_{LIFT_EIC}) may be estimated using the model of the venturi or ejector 230 (ER_{_EJC_MODEL}). The target pressure lift of the recirculation pump or blower 220 (ΔP_{_BLWR_TRGT}) may be estimated as the difference between the pressure lift (ΔP_{LIFT}) required to overcome the pressure loses in the AGR loop 224 and the pressure lift capability of the venturi or ejector 230 (ΔP_{LIFT_EIC}).

ΔP_{_BLWR_TRGT}=ΔP_{LIFT}−ΔP_{LIFT_EJC} (52)

Nominal speed of the recirculation pump or blower 220 (N) may be function of the model of the recirculation pump or blower 220, the operating curve of the recirculation pump or blower 220, the pressure lift of the recirculation pump or blower 220 (ΔP_{_BLWR}), the density of the recirculation flow stream 226 (ρ_{B}), and the target volumetric flow rate of the recirculation flow stream 226 (Vdot_{RC_TRGT}).

N=f(model, operating curve, ΔP_{_BLWR,} Vdot_{RC_TRGT}, ρ_{B}) (53)

ρ_{B}=P_{B}/(R_{_B}×T_{B}) (54)

R_{_B} is the universal gas constant of the recirculation flow stream 226, P_{B} is the pressure of the recirculation flow stream 226, T_{B} is the temperature of the recirculation flow stream 226.

Feedback loops may be used to assess the health of the excess fuel ratio (λ_{H2}) delivered to the fuel cell stack 12. Alternatively, or additionally, other diagnostic tools such as flow assessment from using pressure sensors across different elements or determined using mixing temperature calculations as described above may be used to assess the health of the excess fuel ratio (λ_{H2}) delivered to the fuel cell stack 12.

A net electrical power draw of the recirculation pump or blower 220 may be measured and compared to expected value. The expected value of net electrical power draw of the recirculation pump or blower 220 may derived via calibration:

m_{_RC}=f(N, ρ_{_RC}, PW_{BLW}) (55)

N is the speed of the recirculation pump or blower 220, and PW_{BLW} is the power draw of the recirculation pump or blower 220.

The target mass flow rate through the recirculation pump or blower 220 (m_{_BLWR_TRGT}) may depend on the minimum entrainment ratio (ER_{MIN}) and the mass flow rate of the primary flow stream 202 (m_{_A}).

m_{_BLWR_TRGT}=ER_{MIN}×m_{_A} (56)

The target mass flow rate through the recirculation pump or blower 220 (m_{_BLWR_TRGT}) may depend on a target entrainment ratio different from the minimum entrainment ratio (ER_{MIN}).

In one embodiment, a correlation based ejector model may be used. A correlation based model may use a look-up table to estimate the entrainment ratio from the ejector model (ER_{_EJT_MODEL}) for a given set of boundary conditions. The boundary conditions may comprise the primary nozzle inlet pressure (P_{O}), the secondary inlet pressure (P_{S}), the anode inlet manifold pressure (P_{AIM}) of the fuel cell or fuel cell stack 12, the exit pressure of the flow stream at the venturi or ejector 230 exit 238 (P_{C}), the pressure lift (ΔP_{LIFT}), and/or composition of the recirculation flow stream 226.

The correlation based ejector model may use parameters including but not limited to P_{C}/P_{S}, P_{C}/P_{O}, universal gas constant for the primary flow stream 202/420 (R_{_A}), universal gas constant for the recirculation flow stream 226 (R_{_B}). R_{_B} may be a function of fuel supply pressure (P_{CV}), fuel supply temperature (T_{CV}), and/or other variables. Variables may include but are not limited to variables that provide information on fuel cell or fuel cell stack operating state such as fuel cell current or current density, fuel cell stack voltage or fuel cell voltages.

The venturi or ejector may have an effective efficiency (η). The effective efficiency (η) may vary with operating conditions of the ejector. The effective efficiency (η) may depends on the mass flow rate of the primary fuel stream 202/420, the exit pressure of the flow stream at the venturi or ejector 230 exit 238 (P_{C}), and/or the secondary inlet temperature (T_{S}).

η=f(m_{_A}), or (57)

η=f(m_{_A}, T_{S}), or (58)

η=f(m_{_A}, T_{S}, P_{C}) (59)

The reversible entrainment ratio (RER) or the reversible portion of the entrainment ratio (ER) based on the thermodynamic limits, is defined as:

RER=−Δχ_{_M}/Δχ_{_S} (60)

Δχ_{_M} is the motive flow exergy and Δχ_{_S} is the entrained flow exergy. In one embodiment, the reversible entrainment ratio (RER) of the fuel cell system 10/13 for a given set of boundary conditions can be estimated as:

Δχ_{_M}=C_{P_A}(T_{C}−T_{O})+C_{P_A}ln(T_{C}/T_{O})−R_{_A}ln(P_{C}/P_{O}) (61)

Δχ_{_S}=C_{P_B}(T_{C}−T_{S})+C_{P_B}ln(T_{C}/T_{S})−R_{_B}ln(P_{C}/P_{S}) (62)

In one embodiment, entropy of mixing is not considered because there may not be any elements of the venturi or ejector 230 design that target recovery of chemical potential associated with entropy of mixing.

If T_{S}=T_{O},

RER=−R_{_A}ln(P_{C}/P_{O})/R_{_B}ln(P_{C}/P_{S}) (63)

The correlation based ejector model may depend on the efficiency of the venturi or ejector 230 and the reversible entrainment ratio (RER). The entrainment ratio determined by the model (ER_{MODEL}) may be given by:

ER_{MODEL}=η×RER (64)

If the entrainment ratio determined by the model (ER_{MODEL}) is less than the nominal entrainment ratio (ER_{NOM}), the recirculation pump or blower 220 may be turned on.

In one embodiment, a component based model may be used. The component model may comprise determining a breakdown pressure (P_{BREAKDOWN}) for a given primary nozzle inlet pressure (P_{O}), the secondary inlet pressure (P_{S}), ejector nozzle efficiency, and/or ejector mixer efficiency. The component model may comprise determining the critical pressure for a given primary nozzle inlet pressure (P_{O}), the secondary inlet pressure (P_{S}), ejector nozzle efficiency, and/or ejector mixer efficiency. The critical pressure (P_{CRIT}) is defined as the venturi or ejector exit pressure below which the flows within the venturi or ejector mixer are choked, i.e. the venturi or ejector is double choked.

The component model may determine an estimated entrainment ratio (Λ_{ESTIMATED}) by evaluating or comparing the target anode inlet manifold pressure (P_{AIM_TRGT}) to the breakdown pressure (P_{BREAKDOWN}) and to the critical pressure (P_{CRIT}) at the given operating conditions.

Λ_{ESTIMATED}=(P_{BREAKDOWN}−P_{AIM_TRGT})/(P_{BREAKDOWN}−P_{CRIT}) (65)

When a component based model is used, the entrainment ratio determined by the model (ER_{MODEL}) may be given by:

ER_{MODEL}=Λ_{ESTIMATED}×ER_{DOUBLE_CHOKED} (66)

ER_{DOUBLE_CHOKED} is the entrainment ratio when the fuel cell system 10/13 is double choked under the given operating conditions. If the entrainment ratio determined by the model (ER_{MODEL}) is different than a target entrainment ratio (ER_{MIN}), the recirculation pump or blower 220 may be turned on/off or the speed of the recirculation pump or blower 220 may be altered. The estimated entrainment ratio (Λ_{ESTIMATED}) may overestimate the irreversible portion or the entrainment ratio, so there may be an inherent protection of the entrainment ratio ˜0.35.

For example, the entrainment ratio determined by the model (ER_{MODEL}) may consistently underestimate the actual entrainment ratio (ER). In one embodiment, this underestimation may not be corrected, providing a level of protection to ensure entrainment ratio (ER) is met robustly. This may ensure that the recirculation pump or blower 220 may be turned on when not needed and/or provide a margin for measurement uncertainties. In other embodiments, a correction factor and/or an additional term may be added to the entrainment ratio determined by the model (ER_{MODEL}) to account for the underestimation.

The component model may comprise estimating the reversible entropy loss of the primary or motive flow 202/420 (Δs_{_REV_M}) and of the recirculation or entrained flow 226 (Δs_{REV_M}. The component model may comprise determining the generated entropy loss of the primary or motive flow 202/420 (Δs_{_GEN_M}) and of the recirculation or entrained flow 226 (Δs_{_GEN_E}). The entrainment ratio determined by the model (ER_{MODEL}) may be given by:

ER_{MODEL}=(Δs_{_REV_M}−Δs_{_GEN_M})/(Δs_{_REV_E}−Δs_{_GEN_E}) (67)

Δs_{_REV_M}=C_{P_A}ln(T_{C}/T_{O})−R_{_A}ln(P_{C}/P_{O}) (68)

Δs_{_REV_E}=C_{P_B}ln(T_{C}/T_{S})−R_{_B}ln(P_{C}/P_{S}) (69)

Δs_{_GEN_M}=f(Ma_P2, η_{_MIXER}) (70)

Δs_{_GEN_E}=f(η_{_SUCTION}, Ma_S2, η_{_MIXER}) (71)

Ma_P2 is the Mach number in the primary nozzle of the venturi or ejector 230. Ma_S2 is the Mach number in the suction chamber of the venturi or ejector 230. η_{MIXER} is efficiency of the mixer of the venturi or ejector 230. η_{_SUCTION} is efficiency of the suction chamber of the venturi or ejector 230.

Since the entropy losses are dependent on the Mach number in the suction chamber of the venturi or ejector 230 (MA_S2), which is dependent on the entrainment ratio of the fuel cell system 10/13, a numerical methods may be required to solve the model described above. For example, the entrainment ratio when the fuel cell system 10/13 is choked for a given set of operating or boundary conditions (ER_{CHOKED}) may be determined. The entropy loss of the primary or motive flow 202/420 (Δs_{_GEN_M}) may be calculated for a range of Λ=ER/ER_{CHOKED}, where Λ ranges from about 1 to about 1.0. Mach number in the suction chamber of the venturi or ejector 230 (MA_S2), and the Mach number in the primary nozzle of the venturi or ejector 230 (MA_P2) may be used for the calculation of the entropy loss of the primary of motive flow 202/420 (Δs_{_GEN_M}). The entropy loss of the recirculation or entrained flow 226 (Δs_{_GEN_E}) may be calculated for the same range of Λ=ER/ER_{CHOKED}. The entrainment ratio determined by the model (ER_{MODEL}) may be given by:

ER_{MODEL}=f(Λ, boundary conditions) (72)

The Λ for which ER_{MODEL}=Λ×ER_{CHOKED} may be determined. If the entrainment ratio determined by the model (ER_{MODEL}) is less than the nominal entrainment ratio (ER_{NOM}), the recirculation pump or blower 220 may be turned on.

As previously described, the blower pressure (ΔP_{_BLWR}) is a function of the Q, N, ρ.

ΔP_{_BLWR}=f(Q_{_BLWR}, N, ρ) (73)

Q_{_BLWR}, the flow rate through the recirculation pump or blower 220 may be determined based on the performance and/or operation of the venturi or ejector 230 at a given secondary inlet pressure (P_{S}), primary nozzle inlet pressure (P_{O}), and the anode inlet manifold pressure (P_{AIM}).

The integrated controls of the venturi or ejector 230 and the recirculation pump or blower 220 comprising one or more controllers such as the blower controller 229 may monitor the conditions at which the venturi or ejector 230 may need the support of the recirculation pump or blower 220 to deliver the required entrainment ratio (ER). In some embodiments, the integrated controls of the venturi or ejector 230 and the recirculation pump or blower 220 comprising one or more controllers such as the blower controller 229 or ejector controller 239 may monitor the primary nozzle inlet pressure (P_{O}), the anode inlet pressure (P_{AIM}), the required pressure lift (ΔP_{LIFT}), the temperature change across the recirculation pump or blower 220, and/or the recirculation pump or blower 220 power.

The venturi or ejector 230 and/or the recirculation pump or blower 220 may have a sensor to monitor variables including but not limited to fuel density, fuel mass flow, fuel volumetric flow, primary nozzle inlet pressure (P_{O}), and secondary inlet pressure (P_{S}), and/or the pressure lift (ΔP_{LIFT}), the temperature change across the recirculation pump or blower 220, or the recirculation pump or blower 220 power. In some embodiments, the sensor may be a virtual sensor and/or physical sensor.

Amodel or simulation of the fuel cell system 10/13 may be used to predict when the venturi or ejector 230 requires recirculation pump or blower 220 support. The integrated controls of the venturi or ejector 230 and the recirculation pump or blower 220 comprising one or more controllers such as the blower controller or ejector controller may send target performance/operation values based on the model or simulation to the recirculation pump or blower 220. The model of the recirculation pump or blower 220 may use the recirculation pump or blower 220 operating conditions and the target performance of the recirculation pump or blower 220 to determine the operation of the recirculation pump or blower 220.

The speed of the recirculation pump or blower 220 may be predicted based on the model or simulation of the fuel cell system 10/13. In some embodiments, the model or simulation of the fuel cell system 10/13 may predict changes in variables including but not limited to fuel volumetric flow, primary nozzle inlet pressure (P_{O}), and secondary inlet pressure (P_{S}), the pressure lift (ΔP_{LIFT}), the temperature change across the recirculation pump or blower 220, and/or the recirculation pump or blower 220 power.

The integrated controls of the venturi or ejector 230 and the recirculation pump or blower comprising one or more controllers such as the blower controller 229 or ejector controller 239 may be used to run diagnostics on the fuel cell system 10/13. The integrated controls of the venturi or ejector 230 and the recirculation pump or blower 220 comprising one or more controllers such as the blower controller or ejector controller may compare the actual measurements of variables including but not limited to fuel density, fuel mass flow, fuel volumetric flow, primary nozzle inlet pressure (P_{O}), and secondary inlet pressure (P_{S}), and/or the pressure lift (ΔP_{LIFT}) made using pressure sensors 263 to the expected measurements of variables including but not limited to fuel density, fuel mass flow, fuel volumetric flow, primary nozzle inlet pressure (P_{O}), and secondary inlet pressure (P_{S}), the pressure lift (ΔP_{LIFT}), the temperature change across the recirculation pump or blower 220, and/or the recirculation pump or blower 220 power determined using the model or simulation of the fuel cell system 10/13.

The integrated controls of the venturi or ejector 230 and the recirculation pump (blower) 220 comprising one or more controllers such as the blower controller or ejector controller may use information such as fuel cell stack 12 voltage to diagnose whether a fuel management system monitoring/controlling the fuel cell system 10/13 is delivering required flow rate.

Adaptive control methods may be used to incorporate or retain any required adjustments. For example, stack voltage and cell voltage measurements may be used to incorporate or retain any required adjustments. In some embodiments, the entrainment ratio determined by the model (ER_{MODEL}) may be used by one or more controller(s) such as the blower controller 229, the by-pass valve controller 449, or the ejector controller 239 as a diagnostic tool. In some embodiments, the blower controller 229, the by-pass valve controller 239, or the ejector controller 449 may be the same.

The one or more controllers 229, 239, 249 for monitoring and/or controlling the operation of the recirculation pump or blower 220 in the fuel cell system 10/13, measuring and/or controlling the excess flow ratio (λ) or entrainment ratio (ER), controlling the by-pass valve or controlling the operation of one or more venturi or ejectors 230 may be implemented, in some cases, in communication with hardware, firmware, software, or any combination thereof present on or outside the in the fuel cell system 10/13 comprising the fuel cell or fuel cell stack 12. In some embodiments, the one or more controllers 229, 239, 249 for monitoring and/or controlling the physical or virtual sensors 262, 263 used in the fuel cell system 10/13 may be implemented, in some cases, in communication with hardware, firmware, software, or any combination thereof present on or outside the fuel cell system 10/13 comprising the fuel cell 20 or fuel cell stack 12. Information may be transferred to the one or more controllers using any one or more communication technology (e.g., wired or wireless communications) and associated protocols (e.g., Ethernet, InfiniBand®, Wi-Fi®, Bluetooth®, WiMAX, 3G, 4G LTE, 5G, etc.) to effect such communication.

The one or more controllers 229, 239, 249 may be in a computing device. The computing device may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The computing device may include an input/output (I/O) subsystem, a memory, a processor, a data storage device, a communication subsystem, a controller, and a display. The computing device may include additional and/or alternative components, such as those commonly found in a computer (e.g., various input/output devices), in other embodiments. In other embodiments, one or more of the illustrative components may be incorporated in, or otherwise form a portion of, another component. For example, the memory, or portions thereof, may be incorporated in the processor.

The following described aspects of the present invention are contemplated and non-limiting:

A first aspect of the present invention relates to a fuel stack system or apparatus. The fuel cell stack system includes a first flow stream and a second flow stream mixing to form a third flow stream and a controller. The third flow stream flows through an anode inlet in a fuel cell stack in the fuel cell stack system. The controller compares an excess fuel ratio of the fuel cell stack system to a target excess fuel ratio of the fuel cell stack system.

A second aspect of the present invention relates to a method of determining an excess fuel ratio of a fuel cell stack system or apparatus. The method includes the steps of mixing a first flow stream and a second flow stream to form a third flow stream, flowing the third flow stream through an anode inlet in a fuel cell stack, and using a controller to compare an excess fuel ratio of the fuel cell stack system to a target excess fuel ratio of the fuel cell stack system.

In the first and second aspect of the present invention, the fuel cell stack system may further include a blower, an ejector, or a by-pass valve. In the first and second aspect of the present invention, the controller may determine and/or the method may further include the controller determining when to operate the blower or may determine the blower speed depending on the excess fuel cell stack system. In the first and second aspect of the present invention, the controller may determine and/or the method may further include the controller determining the operation of the by-pass valve depending on the excess fuel ratio of the fuel cell stack system. In the first and second aspect of the present invention, the fuel cell stack system may include a first ejector and a second ejector. The controller may determine and/or the method may further include the controller determining whether to operate the first ejector, the second ejector, or both the first and second ejectors depending on the excess fuel ratio of the fuel cell stack system.

In the first and second aspect of the present invention, the fuel cell stack system may include at least one physical or virtual sensor. In the first and second aspect of the present invention, the physical or virtual sensor may be a single point pressure sensor or a differential pressure sensor. In the first and second aspect of the present invention, the physical or virtual sensor may measure and/or the method may further include the physical or virtual sensor measuring pressure across the fuel cell stack, measure and/or measuring pressure across an ejector, or measure and/or measuring pressure across a blower in the fuel cell stack system. In the first and second aspect of the present invention, the controller may further measure and/or the method may further include the controller determining and/or measuring mass flow rate in the first flow stream or the mass flow rate in the second flow stream. The controller may determine and/or the method may further include the controller determining an entrainment ratio of the fuel cell stack system based on the measured pressure across the fuel cell stack or the measured pressure across the ejector, and based on the measured mass flow rate in the first flow stream or the measured mass flow rate in the second flow stream.

In the first and second aspect of the present invention, if the entrainment ratio of the system is different than a target entrainment ratio, the controller may operate and/or the method may further include the controller operating the blower, alter and/or altering the speed of the blower, operate and/or operating one or more ejectors, or operate and/or operating the by-pass valve. If the one or more ejectors and/or the fuel cell stack system includes a first ejector and a second ejector, the controller may determine and/or the method may include the controller determining the operation of the first ejector and the second ejector. In the first and second aspect of the present invention, the entrainment ratio may have an uncertainty of less than 12%.

In the first and second aspect of the present invention, the physical or virtual sensor may include a temperature sensor. In the first and second aspect of the present invention, the temperature sensor may measure and/or the method may further include the temperature sensor measuring a temperature difference across a mixing point in the fuel cell stack system. In the first and second aspect of the present invention, the controller may determine and/or the method may further include the controller determining an entrainment ratio of the fuel cell stack system based on the temperature difference across the mixing point by using energy balance in the fuel cell stack system. In the first and second aspect of the present invention, the temperature difference across the mixing point may be maximized.

In the first and second aspect of the present invention, if the entrainment ratio of the fuel cell stack system is different than a target entrainment ratio, the controller may operate and/or the method may further include the controller operating a blower, alter and/or altering the speed of the blower, operate and/or operating one or more ejectors, or operate and/or operating a by-pass valve. If the one or more ejectors includes a first ejector and a second ejector, the controller may determine and/or the method may include the controller determining the operation of the first ejector and the second ejector.

In the first and second aspect of the present invention, the controller may use and/or the method may further include the controller using a model to determine an entrainment ratio of the fuel cell stack system based on operating conditions of the fuel cell stack system.

In the first and second aspect of the present invention, a model may be used to determine the entrainment ratio of the fuel cell stack system based on operating conditions of the fuel cell stack system. The model may be a correlational model or a component based model. In the first and second aspect of the present invention, the fuel cell stack system may further include a blower, and the controller may operate and/or the method may further include the controller operating the blower or alter the speed of the blower if the entrainment ratio of the fuel cell stack system is different than a target entrainment ratio of the fuel cell stack system. In the first and second aspect of the present invention, the fuel cell stack system may include a first ejector and a second ejector. The controller may further determine and/or the method may further include the controller determining whether to operate the first ejector, the second ejector, or both the first ejector and the second ejector depending on the excess fuel ratio of the fuel cell stack system.

In the first and second aspect of the present invention, the controller may use and/or the method may further include the controller using a diagnostic tool to adapt the model. In the first and second aspect of the present invention, the diagnostic tool may include using and/or may comprise fuel cell voltage, fuel cell stack voltage, a pressure sensor, or a temperature sensor to determine the entrainment ratio of the fuel cell stack system.

In the first and second aspect of the present invention, the fuel cell stack system may include a blower and the model used to determine the entrainment ratio of the fuel cell stack system may be a blower model that predicts performance of the blower based on operation conditions of the fuel cell stack system.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

. As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third,” and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell stack system comprising:
a first flow stream and a second flow stream mixing to form a third flow stream,
the third flow stream flowing through an anode inlet in a fuel cell stack in the fuel cell stack system, and
a controller,
wherein the controller compares an excess fuel ratio of the fuel cell stack system to a target excess fuel ratio of the fuel cell stack system.

2. The system of claim 1, wherein the fuel cell stack system further comprises a blower, an ejector, or a by-pass valve.

3. The system of claim 2, wherein the controller determines when to operate the blower or determines the blower speed depending on the excess fuel ratio of the fuel cell stack system.

4. The system of claim 2, wherein the controller determines the operation of the by-pass valve depending on the excess fuel ratio of the fule cell stack system.

5. The system of claim 2, wherein the fuel cell stack system comprises a first ejector and a second ejector, and the controller determines whether to operate the first ejector, the second ejector, or both the first and second ejectors depending on the excess fuel ratio of the fuel cell stack system.

6. The system of claim 1, wherein the fuel cell stack system comprises at least one physical or virtual sensor.

7. The system of claim 6, wherein the physical or virtual sensor is a single point pressure sensor or a differential pressure sensor.

8. The system of claim 7, wherein the physical or virtual sensor measures pressure across the fuel cell stack, measure pressure across an ejector, or measure pressure or across a blower in the fuel cell stack system.

9. The system of claim 8, wherein the controller further measures mass flow rate in the first flow stream or the mass flow rate in the second flow stream, and wherein the controller determines an entrainment ratio of the fuel cell stack system based on the measured pressure across the fuel cell stack or the measured pressure across the ejector, and based on the measured mass flow rate in the first flow stream or the measured mass flow rate in the second flow stream.

10. The system of claim 9, wherein if the entrainment ratio of the system is different than a target entrainment ratio, the controller operates the blower, alters the speed of the blower, operates one or more ejectors, or operates the by-pass valve, and wherein if the one or more ejector comprises a first ejector and a second ejector, the controller determines the operation of the first ejector and the second ejector.

11. The system of claim 9, wherein the entrainment ratio has an uncertainty of less than about 12%.

12. The system of claim 6, wherein the physical or virtual comprises a temperature sensor.

13. The system of claim 12, wherein the temperature sensor measures a temperature difference across a mixing point in the fuel cell stack system.

14. The system of claim 13, wherein the controller determines and entrainment ratio of the fuel cell stack system based on the temperature difference across the mixing point by using energy balance in the fuel cell stack system.

15. The system of claim 13, wherein the temperature difference across the mixing point is maximized

16. The system of claim 14, wherein if the entrainment ratio of the fuel cell stack system is different than a target entrainment ratio, the controller operates a blower, alters the speed of the blower, operates one or more ejectors, or operates a by-pass valve, and wherein if the one or more ejector comprises a first ejector and a second ejector, the controller determines the operation of the first ejector and the second ejector.

17. The system of claim 1, wherein the controller uses a model to determine an entrainment ratio of the fuel cell stack system based on operating conditions of the fuel cell stack system.

18. The system of claim 6, wherein a model is used to determine the entrainment ratio of the fuel cell stack system, and wherein the model is a correlational model or a component based model.

19. The system of claim 18, wherein if the fuel cell stack system comprises a first ejector and a second ejector, and wherein the controller further determines whether to operate the first ejector, the second ejector, or both the first ejector and the second ejector depending on the excess fuel ratio of the fuel cell stack system.

20. A method of determining an excess fuel ratio of a fuel cell stack system comprising:
mixing a first flow stream and a second flow stream to form the third flow stream,
flowing the third flow stream through an anode inlet in a fuel cell stack, and
using a controller to compare an excess fuel ratio of the fuel cell stack system to a target excess fuel ratio of the fuel stack system,
measuring pressure across the fuel cell stack or measuring pressure across an ejector, or measuring pressure across a blower by using a physical or virtual sensor.
